(19) United States
(12) Patent Application Publication
(10) Pub. No.: US 2015/0036820 A1
(43) Pub. Date: Feb. 5, 2015

(54) Probability Durable Entropic Advantage

(71) Applicant: Gideon Samid, Rockville, MD (US)

(72) Inventor: Gideon Samid, Rockville, MD (US)

(21) Appl. No.: 13/954,741

(22) Filed: Jul. 30, 2013

(51) Int. Cl. H04L 29/06

(52) U.S. Cl. CPC H04L 63/0428
USPC 380/255

(57) ABSTRACT

A method used by two strangers subject to comprehensive eavesdropping, and in need for establishing privacy and secrecy, or more generally, an entropic advantage. Unlike the prevailing one-way functions, like RSA, and ECC which are subject to a breach via advanced mathematical insight, the method herein is based on durable probability considerations which is vulnerable to faster computing, but not to new mathematical insight, and as such provide more security against powerful eavesdropping adversaries. The method includes an equivocation-based one-way function Y=f(X) where X and Y are any positive integers and where there are infinite values X₁, X₂, . . . Xᵢ such that Y=f(Xᵢ).

### CROSS REFERENCE TO RELATED APPLICATIONS

This application claims as priority date provisional application filed by the same inventor, Application No. 61/741,870 filed on Jul. 30, 2012 entitled: “Innovation Package G27” and it also claims as reference U.S. Pat. No. 6,823,068

### BRIEF SUMMARY OF THE INVENTION

Privacy and secrecy between two strangers who are subject to comprehensive eavesdropping is a critical capability for Internet commerce, and happenstance cyber-exchange. Today it is achieved through one-way functions (e.g. RSA, ECC) which are subject to secret mathematical cryptanalysis that may violate their users' privacy while they believe it is intact. This invention suggests achieving the same objective using durable probability considerations which are susceptible only to faster computing, not to surprise mathematical insight. The privacy and security is defined as ‘entropic advantage’ which may be lasting or ephemeral, slight or major, but one which can be credibly appraised in as much as adversarial computing power may be credibly estimated. Being probability based, the procedure does not provide absolute guarantee of privacy or secrecy, but it is not vulnerable to an adversary with advanced mathematical insight.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

It is a common requirement for two strangers who meet in cyberspace, and use only open communication channels to build privacy and secrecy between them. The prevailing one-way functions that satisfy such requirements are subject to undisclosed cryptanalysis, and therefore a need arises for a means to achieve such ‘entropic advantage’ which is not subject to be breached by advanced mathematical insight.

### DETAILED DESCRIPTION OF THE INVENTION

We begin by introducing a mathematical procedure referred to as: “Crypto Square:”

### Z⁺→Z⁺ with Infinite Solutions to the Crypto-Square Root Equation

Abstract:

A natural number, X, may be mapped to another natural number Y, referring to the mapping as a “Crypto Square” algorithm, and to the reverse as “Crypto Square Root”: Y=X²|_{c} and X=\sqrt{Y}|_{c}. While the crypto-square mapping is a proper function, the square root equation has infinite solutions. There exists a deterministic solution algorithm to find any desired number of solutions to a square-root equation, while the identity of the particular X that was squared to a given Y remains protected with the equivocation of the infinity of solutions. Also, since the range of the mapping is Z⁺, the chance of collision for any finite size set is negligible. These attributes suggest some examination of this “square” algorithm for possible useful roles in various crypto protocols, especially protocols concerned with privacy, authentication and deniability.

### Introduction

A recurring and interesting challenge in cryptography amounts to communicating a secret to a partner without disclosing information to hostile observers. One way to do it is to encrypt the secret with a reliable cipher. Another is to communicate a property of the secret, such that the value of the property will convince the partner as to the identity of the secret, but keep the hostile observer with sufficient uncertainty for that matter. The problem with encryption is that all mainstay ciphers are based on assumed intractability, which in turn can erode faster than anticipated, compromising the secret while it is still hot. Alas, the problem with the property communication is that in order for the property to totally convince the recipient of the identity of the secret, it must be a bijection, and no other secret-candidate will have the same value for that property. But in that case, sooner or later the hostile observers will identify the secret—also without any equivocation. And if there are other secret candidates that have the same property value, then the hostile observers will remain equivocated, but so will be the case for intended recipient. So the property-method depends on creating an entropical gap between the intended recipient of the secret, and the hostile observer.

The advantage of the property-method is that if the chosen property behaves sufficiently random-like then, the respective cryptanalysis will depend only on the hostile computing power, and will not be subject to a mathematical insight that would undermine the system.

So it seems that the property method is of some interest for cryptographic purposes. In this work we explore the question of selecting good properties to be used for safely communicating a secret. We call such property as an engineered-property (EP), and we ask ourselves what are the characteristics of a good EP? Clearly a good EP should be deterministic: the secret in question will have one value for the EP, and no more than one. Second, the reverse computing should be intractable: namely if Y is the engineered property of secret X, Y=EP(X), then X=EP⁻¹(Y) should be prohibitively difficult to compute.

If EP⁻¹ intractability is based on assumed complexity then one is vulnerable to an adversary with greater mathematical insight to compromise it. Also if the selection sets from which X is drawn is finite, the hostile observer will be able to apply brute force cryptanalysis. It is possible to engineer a relief from both the adversarial mathematical edge, and from the brute force attack. This is by way of equivocation. If we select EP such that the equation:

X=EP⁻¹(Y) Eq-1

has n>1 solutions then the hostile observer will face irreducible equivocation. And ideally for infinite number of solutions: n→∞, the observer will be without any advantage after spotting Y relative to where he was before spotting Y. (as long as X was selected from either an unbound selection set, or from a selection set that the adversary is not aware of). If on top of these characteristics we add the requirement that Eq-1 will be readily solvable, such that any desired number of solutions will be readily extracted, then we also endow the communicating parties with the “golden ark” of privacy: deniability. Under pressure to reveal the identity of X given Y, the communicating party will admit any computed solution

X′=EP⁻¹(Y)

as the secret in question. The hostile adversary will not be able to mathematically distinguish between X and X′.

In order to discover such an EP we may first define the secret as being drawn from an infinite list, the natural numbers. The EP value will be equally expanse, also drawn from the list of natural numbers:

XεZ⁺→YεZ⁺

Unlike hashing, which is another mechanism to communicate a property of a secret, the EP should allow for any size X to map into any size Y. In other words, the size of Y will not betray any information as to the size of X. There are probably many EPs that qualify per the above requirements. We here present one concept: “Squaring with Additions”.

### Squaring with Additions

This method is based on an algorithm defined as “crypto self addition”, or “crypto addition” or simply “addition” where no confusion arises. A natural number X may be crypto added to itself, written as:

2X|_{c}=(X+X)|_{c}

Where the addition is defined as either encryption or decryption, and where the cryptographic key and the plaintext (in case of encryption), or the ciphertext (in case of decryption) are both derived from X. The choice of either encryption or decryption is also derived from the value of X. So defined, any given X can be processed to 2X|_{c} by first determining from the value of X whether the process will be encryption or decryption, and then determining from the value of X what is the input value to the cryptographic option, and what is the cryptographic key that would be used for that option. These determinations completely define the result, so the value of 2X|_{c} is completely determined from X, and also dependent on the selected cipher for encryption and for decryption. Addition so defined, we could self-add the result of self-addition, and so repeat, say m times:

2^{m}X|_{c}=2(2( . . . 2X)) . . . )_{m times}

We shall now further qualify the cipher used for the addition process. It will have the property that for any corresponding pair of plaintext, P, and ciphertext C, it will hold that:

g=ƒ(K,P,C)≧0

where: g=|C|−|P|

The bit size of the ciphertext, |C|, is the same or larger than the bit size of the plaintext, |P|, and g, the size difference, depends on P, C and the cryptographic key K. And further: for every number G as large as desired there are combinations of (K,P,C) such that g=ƒ(K,P,C)>G. In other words, there is no upper bound as to how much larger the ciphertext may be compared to the plaintext. We refer to such a cipher as ‘expansive’. Using an expansive cipher for the process of addition it is clear that the size of the addition is without any necessary correlation with the size of the self added number. Whatever the size of the result of the addition |2X|_{c}|, the size of the added number, |X| may be much much larger, and 2X|_{c} is computed by decrypting the large X to the small |2X|_{c}|, or perhaps its size, |X|, is much smaller than |2X|_{c}|, and |X| was encrypted and enlarged to compute the addition result. Anyone holding 2X|_{c} has no knowledge whether this number was arrived at by expansive encryption, or by a size-reducing decryption. If such non-size correlation applies to a single addition process, then clearly it applies to a sequence of m additions: 2^{m}X|_{c}. The size of the input to the sequence, |X| is non correlated with the size of the output |2^{m}X|_{c}|. We can now define the algorithm for crypto squaring as adding a given natural number X m times:

X²|_{c}=2^{m}X|_{c}

where m is also determined by the value of X. We are particularly interested in the case where m is determined using the concept of “complexity factor”. We also wish to allow for a low threshold for the size of the number to be added. Since the number is the source for selecting between encryption and decryption, and for determining the key and the input string, it stands to reason that such determination may require that the number to be added, or ‘squared’ will be of a minimum size, let's call it x_{threshold}. We can then adjust the definition of addition to state that for a number X where the bit string representation is x bits long, then:

∀|X|=x≦x_{threshold}:2X|_{c}=X²|_{c}=X

Namely a number smaller than x_{threshold} adds to itself and squares to itself. This amounts to a ‘singularity collapse’ which will reduce the efficacy of the squaring operations for certain applications. For most applications such collapse may be handled by squaring off a related number. So if X²|_{c} ends up with collapse, it is likely that (X+α)²|_{c} will not collapse, for some arbitrary a. Otherwise, a modular solution might help, as discussed ahead.

### Complexity Factor Counting of Additions:

We introduce here a method to determine the value of m—the number of additions to be performed on a given natural number X in order that the result counts as the crypto square of X. This method depends on an arbitrary selection of a “complexity factor”, Cf—a natural number of choice. In this implementation X will be successively added until the sequence of additions will register Cf consecutive encryptions, or Cf consecutive decryptions. Since the choice between encryption or decryption depends on the value of X, it follows that the value of m so defined also depends only on X. The followings are examples for sequences of addition that line up to qualify as a squaring process: for a given natural number X, and a selected value Cf=3, we register:

X²|_{c}=2¹¹X|_{c}_{_{—}}->E,D,E,D,D,E,D,E,D,D,D Ex-1

Here “E” stands of encryption, and “D” stands for decryption. The value of X determined the first addition to be of the encryption type, and the result 2X|_{c} determined the next addition (4X|_{c}) to be decryption. The sequence encryption, decryptions “oscillated” until it registered three consecutive decryption steps, and then it stopped (since Cf=3) Clearly, the larger the value of Cf, the more iterations there expected to be for the squaring to be computed. From the definition of squaring it is clear that for the above example, all the following numbers are solutions to the equation:

U=\sqrt{X²}|_{c} Ex 1.1

U=X; U=2X|_{c}; U=4X|_{c}; U=2ⁱX|_{c} or i=1,2, . . . 9 Ex 1.2

proving the inherent equivocation, or the existence of many solutions to the square root equation. If such plurality is disturbing for a certain application, one can suitably modify the formula for the number of additions (the value of m). One option is to use the above condition for Cf consecutive encryptions or decryptions, but not as a mark for the end of addition, but as a mark from where to count as many additions forwards. This change will ‘cure’ the above possible vulnerability. So in the above example (Ex-1) we will have:

X²|_{c}=2^{(2*11)}X|_{c} Ex-2

And Ex-1.1 will not hold, and instead we will have:

(2X)²|_{c}=2^{(2*10)}X|_{c} Ex 2.1

And:

(2^{r}X)²|_{c}=2^{(2*(11-r))}X|_{c} for r=1,2, . . . 9 Ex 2.1

### Fixed m Count:

For some applications this a-priori indeterminate number of iterations needed to compute the square may be unacceptable, and for them one could specify an arbitrary value of m (the number of additions).

### A Work-Back Addition Design

We present here a procedure to effect a crypto addition that is specifically designed for one to be able to work back from a squared result to the squared number. There are numerous such procedures. It works as follows: Let X be a number to be crypto-self added into 2X|_{c}. And let X be written with x bits. Step 1: XOR the rightmost bit with the leftmost bit, to determine the so called ed-bit. If ed=1 then the addition will be comprised of encryption; if ed=0 then the addition will be comprised of decryption. Step 2: remove the rightmost and leftmost bits, (x−2) bits remain, comprising string X′. Step 3: Let t be the smallest natural number for which 2^{t}≧(x−2−t). Let T be the numeric value (normal binary interpretation) of the left most t bits in X′. Such that if t=5, and the 5 leftmost bits are: “01001” then T=9. Let T′=T mod (x−2−t). Now mark the substring of X′ beginning from bit (t+1), and ending with bit: (t+T). This marked string will be regarded as the input string, or say the “pc-string”. Next mark the substring of X′ beginning with bit (t+T′+1), and ending with the last bit of X′. This marked string will be referred to as the key-string. For illustration: Let X be 25 bits long:
X: 1111110010010110110001110

We XOR the rightmost and leftmost bits: 1 _{(X)} 0=1, and the result indicates that this addition will be comprised of encryption, not decryption. We now remove the rightmost and leftmost bits and remain with string:
X′: 11111001001011011000111

which is 23 bits long. The value oft is determined from the condition:

2^{t}≧(23−t)

t=1, 2, 3, 4 are too small, and t=5 is the smallest value of t that satisfies the above inequality. The 5 left most bits are: 11111, therefore T=31, and hence: T′=31 mod (23−5)=13 so now the plaintext (the “pc” string) will be the substring from bit number 6=5+1 to bit: 18=5+13:

plaintext(“pc” string)=0010010110110

and the cryptographic key, will be the substring from bit 19=t+T′+1=5+13+1 to bit 23:

Key=00111

The interesting property of this algorithm is that it lends itself to a “work-back”. Given Y=2X|_{c}, one could pick a random string as key, K, and apply the addition cipher to decrypt Y, using K. The result, U:

U=D(Y,K)

One would now concatenate U with K: ‘U−K’. Let U be comprised of u bits, and K of k bits. One would then find the lowest value oft for which:

2^{t}≧(u+k−t)

And then add to ‘U−K’ on the left t bits such that their value T will satisfy:

T mod(u+k)=u

resulting in the string ‘T-U-K’ (concatenated). Last, one would add “1” as the leftmost bit of TUK, and “0” as the rightmost bit of TUK (or vice versa), and the resultant string: V=“1-TUK-0” when added to itself will generate Y:

2V|_{c}=Y

which is almost certainly not the actual X that was self added to Y (V≠X), but one could claim that he self-added V, while in fact he has self-added X, and since there is no mathematical difference between X and V, such claim will provide robust deniability.

The Samid Cipher (U.S. Pat. No. 6,823,068) Implementation of the Crypto Square Procedure

The Crypto Square procedure described before depends on a choice of a cipher. A qualified cipher will have to allow for a size gap between the ciphertext and the respective plaintext, and that size gap will be determined by the identity of the cryptographic key and the input string (be it a plaintext or a ciphertext, as the case may be). It will also have to be accepting variable size keys. Another desired property is that when used for decryption, it can be set in such a way that the corresponding encryption will yield the input that was decrypted. This, in general, is a problem for a cipher where the ciphertext size is larger than the plaintext size. This property is not mandatory for the Square procedure, but it is necessary for the “work-back” option, which is key for a prospective proof for the existence of many solutions, as well as for deniability defense. The work-back option refers to a procedure that would allow one to find as many as desired solutions to the square root equation. The Samid cipher, U.S. Pat. No. 6,823,068, supports all these conditions, and hence will be selected as a valid implementation option for the Crypto-Square concept. The Samid cipher will work with a threshold size for key and for the “pc” string: k_{threshold}, pc_{threshold}. These variables, in turn, will determine the size of x_{threshold}:

X_{threshold}=k_{threshold}+pc_{threshold}+2+0

The “+0” indicates that in the extreme case where k=k_{threshold}, and pc=pc_{threshold}, the number of bits, t, needed to indicate the separation between the pc string and the k string is t=0. For x>X_{threshold}, the value oft will be determined as follows: For an input natural number X, where |X|=x, we will first strip the leftmost bit and the rightmost bit (that are XORed to determine whether the next step is encryption or decryption), then we separate t leftmost bits, where the value oft is the smallest natural number that satisfies:

2^{t}≧x−2−k_{threshold}−pc_{threshold}

and where T is the numeric value of the so determined leftmost t bits, and hence:

T′=1+T mod(x−2−t−k_{threshold}−pc_{threshold})

We now divide X′ by first removing the t leftmost bits that determine the cut between the “pc” string and the key string, then we divide the remaining (x−2−t) bits as follows: The substring from bit t+1 on X′ to bit t+1+pc_{threshold}+T′ will be the “pc” string, and the remaining substring from bit: t+1+pc_{threshold}+T′+1 to the last one on X′ will be the key string. (See FIG. 1).

Illustration:

let: k_{threshold}=10 bits, and pc_{threshold}=18 bits, while |X|=x=40 bits:

X=1001100100011000111011011011100010110100

We compute:

X_{threshold}=k_{threshold}+pc_{threshold}+2+0=10+18+1+0=29

So x>x_{threshold}.

We first chop off the rightmost and leftmost bits (used to determine that the next step is encryption because 1(XOR) 0=1.), and write X′:

X′=00110010001100011101101101110001011010

We now compute t:

2^{t}≧x−2−k_{threshold}−pc_{threshold}=40−2−10−18=10

which evaluates to t=4. The 4 leftmost bits are “0011” and so T=3, and:

T′=T mod(x−2−t−k_{threshold}=pc_{threshold})=3 mod(40−2−4−10−18)=3 mod 6=3

And hence we divide X′ by first removing the 4 leftmost bits, (the t bits) and then dividing the remaining 34 bits by allocating pc_{threshold}+T′=18+3=21 to “pc” and the rest, 13 bits for the key. As we can see the “pc” string and the key string are both longer than the respective threshold figures. In conclusion, we evaluated the given X string to 21 bits to serve as a plaintext to be encrypted using a Samid cipher with a key k, comprised of 13 bits derived from the same string, X. The Samid cipher works with a flexible size key. So we now need to establish the procedure how to translate the key string to the Samid key (the Samid map). The translation should also allow for an easy “work-back”, meaning for a straight forward algorithm that will solve the square root problem.

### Constructing the Samid Cipher Key

We describe here how to use the cryptographic key string comprised of k bits to construct a bona-fide Samid cipher cryptographic key. The procedure amounts to consecutively using the bits in the cryptographic key to guide the marking of squares in the rectangular or matrix expression of a Samid cryptographic key. To distinguish between the string and the Samid key, we will call the former the key-string, and the latter the Samid-key, or the Samid-map. We shall use Samid cipher with the four letter alphabet X,Y,Z,W. The key is comprised of “square rings” around a starting square, all drawn on a straight Euclidean plane. The starting square (marked W) is ring-0. It is surrounded by 8 squares: 4 squares with a shared edge to the starting square, and 4 squares with only a shared vertex with the starting square. This is square-ring-1. Ring 1 is surrounded by ring 2 comprised of 16 squares, and so on: ring-n is comprised of 8n squares, 4 squares of them are corner squares. All the even rings will be marked with the letter W. The odd rings will be each marked with X, Y and Z as follows. So this particular variety of the Samid map is comprised of layers or rings, which alternate between rings totally marked with W and rings marked with a combination of ‘X’, ‘Y’, and ‘Z’. So ring 0 has 1 square marked W, ring 2 has 8*2=16 squares all marked W, ring 4 has 8*4=32 squares, all marked W, etc. And ring-1 has 8 squares marked with a combination of ‘X’, ‘Y’, and ‘Z’, ring 3 has 24 squares marked with a combination of ‘X’, ‘Y’, and ‘Z’. (See FIG. 2). We shall agree that the outermost ring in a Samid cipher of this variety will always be an even ring, namely a ring all marked with W. We shall describe now how to use the bits in the cryptographic key string as a guide to fill in the current square-ring of the Samid map. For odd ring #n, there are 8n squares to be filled-in, or say marked with either X, or Y, or Z. We determine that the four corner squares will be marked as the square which is next to them, going clockwise. So we are left to determine the marking of u=8n−4 squares. We shall agree that the rings will be filled in or marked by a Fill-In-Procedure (FIP) that will assign the markings of the squares of the ring one by one, going counterclockwise, and starting with the square that defines the intersection between the rightmost column, and the middle row. Later on we shall introduce greater flexibility in marking the squares to reverse the direction, to change the starting square over which to use the FIP to mark the squares, and to use the other 5 orders: X,Z,Y; Y,X,Z; Y,Z,X; Z,XY; Z,Y,X. We shall set: w=u−2, and search for the lowest value of k₁, a natural number such that:

2^{k}^{₁}≧w

We shall then evaluate the numeric value of the first k₁ bits from the key string, to read as the number T, and then compute:

x₁=(T mod w)+1

We shall then fill up the first x₁ squares in the ring with ‘X’ marks. If x₁=w, then the ring has 2 squares left to be assigned. The first will be assigned with a ‘Y’ and the second will be assigned with a ‘Z’. This will conclude the task of marking the ring with X-Y-Z symbols. If x₁<w we shall set: w=u−x₁−1, and similarly, find the lowest value of k₂, such that 2^{k}^{₂}≧w. We shall evaluate the numeric values of the substring of the key string beginning with bit k₁+1 and ending with bit k₁+k₂. Let T′ be its value, from T′ we shall determine:

y₁=(T′ mod w)+1

and will then mark the next y₁ squares in the ring with ‘Y’. If y₁=w, then the ring has only one square left, and it would be marked with 7′. For the other cases, where y₁<w, we shall set w=u−x₁−y₁, and find the lowest value of k₃, such that 2^{k}^{₃}≧w. We shall then examine and evaluate the next k3 bits in the key string. Let them be evaluated to T, and then we compute:

z₁=(T mod w)+1

We shall then fill up the ring with z₁ squares marked ‘Z’. The ring has now u′=u−x₁−y₁−z₁ squares left to be filled. If u′<3 then it is filled with ‘Z’ marks. If u′=3 then the first square is marked with ‘X’, the second with ‘Y’ and the third with ‘Z’. If u′>3 then it is treated as an empty string of squares. In other words, we treat the u′ ordered squares the way we treated the u squares above. And we treat the same the remaining substring from this second round—same as the u′ substring of the first round. We can continue with this procedure, each time leaving a small substring to fill in, until the remaining substring, the new u′ is comprised of three squares or less, and then it is filled in as above. The fill-in procedure (FIP) is applied iteratively then. If we fill in odd ring n, then we must determine the X,Y,Z marking for its 8n squares. The corner squares are excluded, as indicated above, so we are left with u=8n−4 squares to be filled in. Applying FIP over u (reading the bits from the key string), we then remain with u′ unmarked squares (u-u′ squares have been duly marked by the FIP procedure). We then re-apply FIP over the u′ squares, and end up with u″ un-filled squares (duly filling up, or say marking u′-u″ squares). Subsequently, we apply FIP over the u″ unmarked squares until we finish marking all the squares in the ring.

It is straightforward to ascertain that the Samid cipher so constructed is in compliance with the inherent attributes of such a key, mainly that from every reference square marked by any letter, there is a path that leads from it to any and each of the other three letters, and that path is comprised of squares marked by the same letter as in the reference square. (The universal access condition).

Insufficient Key Bits:

A problem arises when there is not sufficient ‘key material’ to determine the marking of the ring. In that case the ring will be marked off the Samid map, and the odd ring before it will be the outmost odd ring. The very construction of the Samid map guarantees (i) that the map will be consistent with the Samid map requirements, and (ii) that every proper allocation of squares to the letters ‘X’, ‘Y’, and ‘Z’ can be covered with a proper bit sequence of the Samid key string. The smallest odd ring has 8 squares. Four of these squares are corner squares which are marked according to the preceding square going counterclockwise. Hence, there are 4 squares left for assignment. We have k₁=1, since 2¹≧4−2. There will be either two squares marked X or one (corner squares not counted), and so the remaining squares, if they are three will be marked X,Y,Z, (according to the rules above), and if they are two will be marked Y,Z. (according to the rules above). And hence a single bit key size is enough to construct a valid Samid-map that is ripe and ready to encrypt any size plaintext.

To further illustrate: a Samid key string comprised of the bit “0” will translate to x₁=(0 mod 2)+1=1. Ring 1 has 8 squares, 4 of them are corner squares, so 4 are left to be assigned by FIP. The key bit “0” assigned one square (marked ‘X’), so 3 squares are left to be marked, and according to the rules above they are marked: X, Y, Z. Ring 1 will now look like:

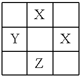

Filling in the corner-squares, per the set rules:

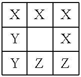

Now adding ring-0 and ring-2 (the outmost ring must be even), the constructed Samid map looks like:

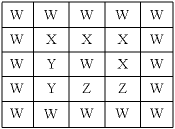

And if the single bit of the Samid key is “1” then we have x₁=(1 mod 2)+1=2. There remain 2 squares to be assigned, and according to the above rules they are assigned ‘Y’—the first and ‘Z’ the second. Accordingly, the Samid map will look like . . . the same as above. We conclude therefore that the first ring of any Samid map in this Crypto-Square version always looks the same, and is always determined by the first bit. We can also say: k_{threshold}=1. Let's see what happens for Ring-3. Ring-1, we have seen is comprised of 8*1−4=4 squares. Ring-2 is the ‘W’ ring, comprised of 8*2=16 squares. And the next ring up, Ring 3 is comprised of 8*3=24 squares. 4 of those squares are corner squares which receive their letter marking from the preceding square, (counterclockwise), so we are left with 20 squares to be letter marked. Lets say the Samid key string looks like:

Key String=X=“10010010001011001110”

The first bit, “1” is used to mark the first ring (ring-1) as we have seen above. The next bits are used as follows: We have w=u−2=20−2=18. We are looking for k₁ such that:

2^{k}^{₁}≧18 and 2^{k}^{₁}⁻¹<18

k₁ evaluates to 5. The 5 next bits from the key string are: “00100”, which is written in decimal as: 4, so x₁=(4 mod 18)+1=5. Meaning that the first 5 squares on ring-3 will all be marked with ‘X’. There are 20−5=15 squares left to be marked. We look for the smallest value to satisfy: k₂≧log(15−1), and conclude that k₂=4. The next 4 bits from the key string are: 1000, or 16 in decimal, and hence: y₂=(16 mod 14)+1=3, and so we mark the 3 next squares with ‘Y’. We are left with 20−5−3=12 squares to mark. We set w=12, and look for k₃, the smallest natural number such that: 2^{k}^{₃}≧12, and the answer is k₃=4. So we pick the next 4 bits from the key string: 1011; the decimal value is: 11, and hence: z₁=(11 mod 12)+1=12. This then assigns letters marks to all the squares in ring-3. The left over key substring is: 001110, which is too short to mark the next ring, ring-5 which is comprised of: 8*5−4=36 squares to assign from the key bits, so these extra bits are ignored, they don't participate in building the map. It's noteworthy that the number of ‘leftover’ bits depends on the number and the identities of the bits beforehand. By design the last X-Y-Z ring is surrounded by a W-ring (even ring). The Samid map key will look like:

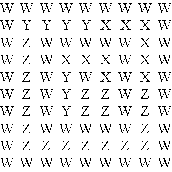

This particular definition of key has one noted restriction: The order of the X-Y-Z letters is always the same, and moving from the center (ring-0) to the right always reads: WXWXWX . . . . This can be avoided in several ways, one way is as follows: The first three bits of the key will indicate the applied order for filling the key, for example:

001—XYZ

010—XZY

100—YXZ

011—YZX

110—ZXY

101—ZYX

and the values “000” and “111” reserved, or used to indicate start and end of the key string respectively. The next bits of the key will be used to indicate the starting point of the marking process. In the above detailed example the starting point was always the same, the rightmost middle square, or square #1. One could replace that with starting the very same procedure as above, but shifted from square #1 to any square #S, as follows:

Let t=8n−4 be the number of squares to be filled from the key string in the particular odd ring #n. We shall look for the smallest natural number s* where 2^{s*}≧t, and then extract the next s* from the key string, and evaluate its value, s**: We shall compute the shift:

S=s** mod t

and apply it. So instead of starting the letter marking at square #1 (the leftmost middle square), we shall start at square #S. This interpretation of 3 bits for the order of X-Y-Z, and S bits for the shift can be repeated before marking any successive ring in the Samid map. Note that the decision whether to add this variance on starting square or order of the markings should be based on the application for which the crypto-square is being used for. For many instances, the simple one where the order is always X-Y-Z and the starting square is the same, will be sufficient.

For Illustration:

let the key string start with: “0110101” We take the first three bits ‘011’ to indicate the order YZX per the table above. The number of squares to be filled in is 8 minus the 4 corner squares: 4. So s*=2 in this case, and the next two bits in the key string are “01”, and so S=(1 mod 4)=1. We therefore shift the starting square by one, and use the indicated order to mark the following map:

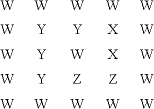

The Special Features of the Samid Cipher:

Crypto-Square does not require the use of the Samid cipher, but that cipher packs the required attributes: (i) g=|C|−|P|=ƒ(K,P,C): the size gap between the ciphertext and the plaintext may be wide ranging and it depends on the identity of the key and the input string (plaintext or ciphertext); (ii) the cipher works with any size key above k_{threshold}, without any upper value limitation; (iii) the key-construction to effect decryption may tailor the opposite encryption to encrypt back to the exact string that was key-constructed for decryption. The last point may need elaboration. The Samid cipher is a one-to-many, many-to-one cipher, where a plaintext P may encrypt into many ciphers C₁, C₂, . . . Cₙ, such that all of them decrypt back into the same plaintext. To prove that a string could have been a result of self-adding many possible strings, the backward designer takes a particular Cᵢ and constructs a Samid key to decrypt it into its matching plaintext, P, such that when the same key is used, it will encrypt to exactly Cᵢ. Alas, it is not necessary that the same key when applied in the reverse, namely to encrypt P, will yield exactly Cᵢ, and not some Cⱼ where i≠j. Yet, the nature of the Samid key is that it allows for the key construction to effect a proper plaintext that would encrypt to exactly the ciphertext that generated it beforehand. This correspondence between the plaintext and ciphertext is essential to the equivocation claim of the crypto-cipher. The Samid cipher by its construction and nature, provides degrees of freedom for the encryption process to choose a variety of pathways to express the same plaintext, and since every pathway is a distinct ciphertext, which decrypts back to the same plaintext, these degrees of freedom allow for the variance, and indetermination of the exact ciphertext, given the plaintext and the key. If these degrees of freedom are left intact then it would harm the crypto square process because when one tries to solve the square root equation, and find a plaintext that would encrypt to the given ciphertext, then it is not enough to build a Samid map, or say a Samid key such that the ciphertext will indeed decrypt to a corresponding plaintext, it is necessary to insure that the key is such that when the said plaintext is fed in for encryption it will generate the very same ciphertext that created it beforehand, and not any other valid ciphertext that decrypts to it. One can insure that the plaintext will encrypt to the desired ciphertext by setting up rules to govern these degrees of freedom, and then constructing the key accordingly. We have built a robust correspondence between the Samid key (map) structure, and a corresponding bit string, so, once the proper map is constructed, it can be expressed with a proper bit string. Here are some of the rules:
The Samid Map is built as successive “square rings”, (“rings”).

The inner “ring” is just a single square, marked W (ring-0). It is surrounded by 8 squares that comprise ring-1. It, in turn is surrounded by ring-2, comprised of 16 squares, and in general ring-n is comprised of 8n squares (for n>0).
All even rings: 0, 2, 4, 6, . . . are all marked with ‘W’.
A Samid key outer ring is even, namely the outer ring is always occupied with W.
All odd rings: 1, 3, 5, . . . are marked with ‘X’, ‘Y’ and ‘Z’ such that each subset of consecutive squares marked by same letter, is terminated by one of the two other letters on one end, and the other (the third) on the other end.

Such that XXXXYYYYYXXXX is a non qualifying substring because the substring comprised of YYYYY is terminated by X marked square on both sides.

In the following we shall refer to the ‘traveler’—this is the essential feature of the Samid cipher: the entity that uses the plaintext as travel guide, and decides which steps to take on the Samid map.
Infinity: if a traveler occupies a square in the rightmost column, and the travel path calls for another right step, then the traveler jumps to the leftmost square in the same row.
Infinity (2): if a traveler occupies a square in the leftmost column, and the travel path calls for another left step, then the traveler jumps to the rightmost square in the same row.
Infinity (3): if a traveler occupies a square in the upper row, and the travel path calls for another upward step, then the traveler jumps to the lowest square in the same column.
Infinity (4): if a traveler occupies a square in the lower row, and the travel path calls for another downward step, then the traveler jumps to the highest square in the same column.
W direction (1): If a W mark is called for, from an X, Y, or Z square then the outer ring of W will be chosen, not the inner one, until the highest ring is reached.
W direction (2): Once the outer ring has been reached the rule for the next ‘W’ switches from opting to the outer ring to opting for the inner ring. When ring-0 is reached, the opting switches again, from inner to outer, and so on, the direction of the choice ‘W’ ring oscillates from inner to outer, indefinitely.
XYZ direction (1): If an X, Y, or Z mark is called for, from a W square then the outer ring of X-Y-Z will be chosen, not the inner one, until the highest X-Y-Z ring is reached.
XYZ direction (2): Once the outer XYZ ring has been reached the rule for the next ‘XYZ’ switches from opting to the outer ring to opting for the inner ring. When ring-1 is reached, the opting switches again, from inner to outer, and so on, the direction of the choice ‘X-Y-Z’ ring oscillates from inner to outer, indefinitely
Choice within an ‘X’-‘Y’-‘Z’ ring (1): Let G be the letter that marks the current square in the Samid cipher process pathway on an odd ring (G may be X, Y, or Z as the case may be). Let H be the next letter indicated by the plaintext (H≠G), and L be the third letter (L≠H, L≠G). Rules:
   Choice-1. If the current square faces two squares marked H, then the one consistent with counterclockwise direction will be chosen.
   Choice-2. If the current square faces one square marked H, that one will be moved into (chosen).
   Choice-3. If the current square faces two G letters, the one consistent with counterclockwise direction will be chosen, unless that letter G was chosen before while the trip was conducted over G marked squares only since that previous choice. In the latter case, the opposite G will be selected.

So for a case like:

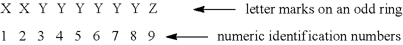

If square marked 5 is the current one (marked ‘Y’), and the plaintext calls for ‘Z’ as the next letter in the pathway, then, because both squares 6 and 4 are marked ‘Y’, the choice, according to the above rules is square 4 because it is counterclockwise (assuming the string shown is the upper side of the ring). This is obviously the bad choice because it moves the pathway towards square marked ‘X’, not ‘Z’, but the rules assumes only visibility of touching neighbors, so the choice-maker at square 5 has no visibility towards where the marking will change to ‘Z’, and where to ‘X’. According to the same rule the state square will move from square 5 to square 4, then to square 3. From square 3 there is no choice except to retreat to square 4 (square 2 is the wrong letter). And then according to the rules above (choice-3) the state square will move from 4 to 5, 6, 7, 8 and finally to square 9 where it abides by the dictates of the plaintext and moves from ‘Y’ to ‘Z’.

By setting up the above rules, one eliminates the degrees of freedom given by a choice of plaintext and key. The rules narrow down the choice of ciphertext to the one intended, among the many possible. The advent of the Samid map is that one can determine the letter markings of each square where the path is stepping through, as well as the letter markings of neighboring squares, to channel the respective ciphertext to the desired pathway. So if a ciphertext is given by an arbitrary bit string, then it may be interpreted as a sequence of up, down, right, left, and mark any path of choice. Given this path it is a straightforward task to build a Samid map ‘under that path’ and mark the traversed squares, as well as the neighboring squares so that a respective plaintext will be marked and listed, and the neighboring squares will be marked so as to insure that the respective encryption will chart the same path as the original string that led to the back-designed decryption.

For example: if the ciphertext has a section ‘D,R,R,D’ (down, right, right, down), this might be effected through a Samid map portion that looks like this:

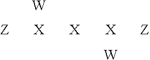

with a corresponding plaintext: WXW, such that on its way back (from plaintext to ciphertext) the two ‘Z’ on the key would force the corresponding pathway to be D,R,R,D.

### The W-String Enhancement

The issue here pertains to design-back difficulty present in the above design. It identifies it, and fixes it.

Our design back is a mechanism to show that given any natural number Y, it is possible to compute an infinity of numbers X₁, X₂, . . . Xₙ such each will square-off to Y. And to do that we need to show that given any natural number, Y, one could find an infinity of numbers X′₁,X′₂, . . . X′ₙ, such that each of them will self-add to Y: 2X′ᵢ|_{c}=Y, for i=1, 2, . . . . We wanted to show that such addition may involve either encryption, or decryption, because in the addition process the self-added number determines whether the process ahead involves encryption or decryption. We clearly realize that there is no problem in design-back for decryption. We simply take any Samid map that we happen to choose, use it to encrypt Y, and then we denote the ciphertext as X″, We then express the used Samid map as a key string K, concatenate K with X″ (K−X″), add the appropriate t bits to allow one to properly separate K−X″ to K and X″, add “1” as a rightmost bit and “1” as a left most bit (or alternatively add “0” for both leftmost and rightmost bit), and so we construct X′, since as designed, we clearly can write:

2(‘1-t-X″-K-1’)|_{c}=Y

We know for sure that X″ will decrypt to Y using the Samid map constructed from K, because the same key was used to encrypt it from Y. The Samid cipher is a one-to-many for encryption, and a many-to-one for decryption, so we know for certain that the decryption will yield Y, and no other. In principle, this would be sufficient because the above shows that we could generate an infinity of solutions to the square-root equations, even though all the generated cases terminate with a decryption, not with an encryption. We claim infinity of solutions because we could assign infinity of Samid maps, of any size. There is a different situation when we try to design-back for addition that involves encryption. In that case we must find a string X′ that would encrypt to Y. We can readily build a Samid key that would decrypt Y to some X′ (in fact any Samid map will do that). The problem arises on the reverse. How to insure that when X′ is encrypted it yields Y, and not some Y′ that too will decrypt to X′. In general there are Y, Y₁, Y₂, . . . Yₙ ciphertexts into which X′ may encrypt, and for our design-back to work we must insure that the encryption process will yield Y and not any of the other possible ciphertexts. (We may also designate the original Y as Y=Y₀ As discussed above, we may try to reduce the degrees of freedom innate in the encryption process by setting forth rules that would determine, how to make choices in case of ambiguity, or degrees of freedom in building the pathway (the ciphertext) from the plaintext (the ‘travel guide’). By taking these rules into account it is possible to mark the squares in the Samid map such that the generated plaintext will encrypt to the desired ciphertext. Such is indeed possible in the vast majority of the cases. And if a case is encountered where no solution is found to force the generated plaintext to encrypt to the specific ciphertext, then one could try again with another Samid map. While the above strategy will work, it may be more elegant to guarantee that for every possible Samid map, it would be possible to force the plaintext to generate the desired ciphertext. It turns out that this is possible using the “W-string” enhancement. It works as follows: It is easy to see that any pathway that is limited to a given odd ring may be programmed such that the corresponding plaintext will necessarily encrypt to the generating ciphertext. If necessary, this can be done by marking the squares of that odd ring as a sequence of X-Y-Z:
. . . X-Y-Z-X-Y-Z-X-Y-Z- . . .

Such basic granularity will be used, if necessary, to represent any given pathway within this ring, in a way that its encryption will lead to the generating pathway. For example, consider a ‘crazy’ pathway in the form (R—right, L—left):
R,L,R,L,R,R,R,L,R,L,L . . .

Suppose that this sequence starts at the middle Y in the above odd ring. The pathway will be faithfully described by the plaintext:
Z-Y-Z-Y-Z-X-Y-X-Y-X-Z . . .

and that plaintext when it is encrypted will generate the exact pathway which generated it. It is a different problem when it comes to even rings populated by W only. When a sequence of right and left is described by the pathway (the ciphertext) over an even ring, then the corresponding plaintext collapses to a single W. And it is a challenge upon encrypting this plaintext how to generate the exact over-W pathway that generated it. Another problem arises when the pathway enters an even ring from an odd ring. Whether the pathway moves to the outer W (even) ring, or to the more internal W (even) ring, the plaintext is expressed the same: W. So upon encryption how to choose the same direction (outer or inner) as was indicated by the exact pathway that generated that plaintext. One may note that the shift from an odd ring to an even ring poses no problem because the W-square where the shift to an odd ring occurs may be marked with two different letters on the outer and inner rings options.

These two problems are to be solved, as follows: We need to insure that a pathway comprised of some back and forth steps over an even (W) ring will be re-constructed when its corresponding plaintext is encrypted. To accomplish this one will generate a “W-guide bit string”, or “W-string” for short. The string will be read from right to left, two bits at a time. When the pathway crosses to an even ring, the procedure calls for reading the 2 rightmost bits in the W-string, and interpret them as follows:
“01” means move to the next W square clockwise.
“10” means move to the next W square counterclockwise
“11” means move to the outer ring upon first chance (when the current state-square becomes adjacent to the next letter in the plaintext), while moving counterclockwise along the even (′W′ ring).
“00” means move to the inner ring upon first chance (when the current state-square becomes adjacent to the next letter in the plaintext), moving clockwise along the even (′W′) ring.

To Illustrate:

Let the W-string be:
11010110100101

Let a plaintext section read as ‘XWY’. Let a slice of even ring (W) and an odd ring (X-Y-Z) be as follows:

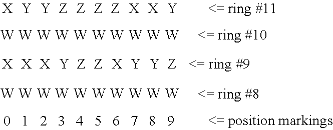

Now suppose that the X indication on the above plaintext slice corresponds to square number 6 on ring #9. Since the next letter in the plaintext specifies ‘W’, the encrypter will have to decide whether to select a ‘W’ on ring #10 or a ‘W’ on ring #8. So the encrypter consults the W-string. The two left most bits on that string are “01”. That means that string at this point does not indicate which W-string to choose. In the absence of such guidance the standard rule will apply: the outer will be selected until the outermost ring is encountered and then the inner ring will be selected. Accordingly the encrypter determines the path as ‘U’ (UP) to square #6 on ring #10. The next plaintext letter is ‘Y’. But the current W-square has 2 W neighbors (in the same ring), one X neighbor (the former state square on ring #9), and one Z, in ring #11. So clearly the path must move one of the possible W squares. The default choice is counterclockwise to Square #5 on ring #10. But the encrypter is bound to consult the W-string for possible preemption of the standard rule. The encrypter will consult the 2 rightmost bits on that string, which have already been examined and found to be: ‘01’, which according to the rules means to move to the next ‘W’ square clockwise. Namely to square #7 on the same even ring. The next two bits are also ‘01’ which instruct the encrypter to move to square #8 on same ring, number 10. The next two pairs of bits indicate two counterclockwise moves, so the path moves from square #8 to square #6. And then to square #7, and to square #8 again. And what is next? the last pair of bits says ‘11’, which indicates move from now on counterclockwise, and shift to the outer ring when possible. So despite the fact that the current square (#8 on ring #10) has a ‘Y’ adjacent to it (on ring #9), it will not move there because the instruction embedded in the ‘11’, and instead it will move counterclockwise on its W-ring, and keep doing so until it reaches square #2 on its ring (#10). So instead of making a simple move down to ‘Y’ on ring #9, the encrypter chose to move 6 times counterclockwise, and then go up to ‘Y’. So according to the W-string, the pathway corresponds to the XWY section of the plaintext is:
Ciphertext (1): U-R-R-L-L-R-R-L-L-L-L-L-L-U

Note that the same plaintext could have been encrypted into Ciphertext(2): ‘U-L-D’. And the way the Samid cipher works both ciphertexts (Ciphertexts, (1) and (2)) would decrypt to the same plaintext. This illustrates how the W-string guides the encrypter to chart a particular cipher. This language is used by one who wishes to decrypt a given string such that it would encrypt to exactly the same given string. What is left to determine is where to find the W-string. The answer is that the W-string concatenates to the “pc” string, or in our case, to the “p” (=“pc”) string, the plaintext. P-W. As the plaintext encrypts it reads its bit from the left, while it looks for W guidance from the right. And that is why the W string is listed from left to right. Eventually the two processes meet. The plaintext, P string's last bit is the one such that the bit right to it was most recently read as W-guidance.

We can now describe how the back-design happens. A bit string marked as Y is to be reverse-added (subtracted) to find string X such that 2X|_{c}=Y. It is desired that this particular addition will involve encryption. To do that the back-designer would select an arbitrary Samid map, K*, and use it to decrypt Y into X*. We know that when X* is encrypted it will follow its standard rules and produce some Y*≠Y as its ciphertext. So the back-designer wishes to compel the encryption process that encrypts X* to produce exactly Y, and not a different ciphertext. We have seen above that any peculiarity in the pathway of Y expressed over an X-Y-Z ring can be readily accounted for by changing the square marking in the initial Samid map, K*, turning it into a modified Samid map: K*′. And just above we have seen how one could design a W-string that would compel the encryption process to follow the pathway of Y as it is expressed over W (even) rings. So the back designer will concatenate the so designed W string, W, next to P. Now when the encryption of P will take place and as the generated ciphertext pathway is about to move into W territory, it will start looking to the W string for guidance. And per its design the P string will finish at the point where the W string offered its last piece of guidance, and the result will be the exact path Y that was the starting point of the back designer. The back-designer will set: X=2⁻²Y|_{c}=‘1’-t-P-W-K*′-‘0’, and the value of the t bits will be designed to separate ‘P-W’ from K*′. By its construction, as above, the addition of X to itself will yield Y. Note: the term ‘back designer’ refers to the designer that builds up a string X that would self-add to the given string Y.

### Tuning

The Crypto-Square concept may be tuned, and specified in a very flexible way, towards perfecting its innate attribute of:

X²|_{c}:Z⁺→Z⁺

Mapping any natural number (or say, a binary string of any length) to another natural number (or, a binary string of any length). The closer the Crypto Square is tuned to its state of perfection, the more valid is its perfection assertion:
Crypto-Square Perfection Assertion: Any finite set of arbitrary natural numbers will have only a negligible chance to have a member that squares to an arbitrary a-priori result.

Well tuned, the Crypto Square mapping will map any arbitrary natural number to any other natural number. Since the value of the square is not limited to any finite subset of the natural numbers, the likelihood that for a given natural number X, that X²|_{c}=A, for any a-priori given arbitrary A, is approaching zero in an infinitesimal sense. And hence, any finite set, S, of natural numbers will have only a negligible chance to have a member XεS, such that X²|_{c}=A. The perfection assertion, along with the infinite entropy property of the square function lead to an important conclusion: If Alice and Bob have each a ‘candidates set’ that may include a match—an element they both share, and if these two candidate sets are taken from a large set S, of which Eve is aware, then by employing the crypto-square tool, Alice and Bob will be able to practically verify a suspected shared candidate, or confirm they have none, while forcing Eve to brute-force check half the elements in S, on average. In other words, the Crypto-Square is one-way function that is immunized from any future mathematical insight to find a computational shortcut for it. That is because it is based not just on intractability, but mainly on equivocation. There are infinite solutions to the respective square-root equation, and all the solutions are mathematically equal. In that respect the crypto square is similar to a hashing procedure. But there is a big difference. While generally a hash has an infinite solutions to the pre-hash number, any arbitrary list of numbers of count 2^{t} or more, where t is the bit size of the hash, has two elements which share a hash; which is markedly different from the perfection attribute.

The tuning option we may categorize as follows:
range tuning
complexity tuning
cipher tuning

### Range Tuning

The theoretical range for Crypto-Square is from an arbitrary low limit, x_{threshold}, to infinity. And the greater the complexity of the procedure the greater the chance for an unbound spread of a set of n squares X₁²|_{c}, X₂²|_{c}, X₃²|_{c}, . . . Xₙ²|_{c}, computed from a random series: X₁, X₂, . . . Xₙ.

This open ended variety is very attractive on theoretical grounds, but rather daunting from a practical standpoint. For certain applications it is advantageous to control the span and replace the absolute Crypto Square with a bounded one:

X²|_{cn}:Z_{N}→Z_{N}

where: X²|_{cn}=X²|_{c} mod N

Or it can be further restricted to a range from a low bound, L to a high bound H:

X²|_{cn}(L,H)=L+(X²|_{c}−L)mod(H−L)

The user can decide on L and H values to control the chance for a mistake, or what is the chance that a set of s elements will have one, x, such that x²|_{c}=A, for an a-priori A. Controlling range with module arithmetic can be used whenever it is necessary to control the range of the results, such as a need to restrict the results into a fixed size field in a database. By making the gap (H-L) small, it is possible to use Crypto-Square as a strong hashing algorithm.

### Complexity Tuning

Complexity tuning may be effected through determination of the complexity factor, Cf, value. For Cf=1 the crypto square becomes an addition:

X²|_{c}=2X|_{c}

One round will yield the square result. Clearly, the larger the value of Cf, the larger the number of rounds of additions (m) that comprise the Crypto-Square, or say, the larger the value of m:

X²|_{c}=2^{m}X|_{c}

Clearly m≧Cf. In the base definition one uses the same complexity factor to count encryptions and to count decryptions. But such is not necessary. It is possible to set a different complexity value for each process: Cfₑ and Cf_{d} (Cf for encryption and Cf for decryptions respectively), and set Cfₑ≦Cf_{d}. So by setting Cfₑ to be high, the squaring will end up with a larger result. Of course, the problem with higher complexity factor is the increased computation burden before the result is achieved. A broader view: A broader view of the complexity issue, is to contrive a rule that would increase the number, and variety of rounds (crypto additions). The rules above had to do with counts of successive encryptions or successive decryptions, but one could use any patters, like: e-e-d-e-d to stop a sequence of addition (e—indicates encryptions, and d indicates decryptions). For applications where it is necessary to insure that the Crypto-Square computed in a given time, it is possible to define a fixed m (number of rounds).

### Cipher Tuning

As described the crypto-addition will work with any well defined cipher for which |C|≧|P|, and especially for those where the gap between the sizes of the ciphertext and plaintext depends on the identity of the key and the input string. Another requirement is that the cipher would accept any size key, above a given threshold. We have found that the Samid cipher, 2004, is a good cipher satisfying the above requirements. We have delineated a particular version of the Samid cipher where the structure is based on ‘rings’ around a given square, and where all even rings are filled with W and all the odd rings are filled with patterns of X, Y and Z. But the crypto square and the addition operation will work on any Samid cipher, not just the particular version described. And for a variety of reasons one could shift to a more attractive variety. In particular it is possible to use the key string to define random letter marking over a given matrix, and then apply a standard adjustment algorithm to force the random markings to comply with the universal access requirement that states that from every square (starting square) it is possible to find a pathway to any of the other three letters, where the pathway will be comprised of squares only marked with the same letter as the starting square. Such a Samid cipher is more randomized because it does not conform to the imposed ring structure described above. Also the Crypto-Square will work with Samid ciphers that are not restricted to the matrix framework, but represent a more general implementation of the cipher.

### Use Tuning

The Crypto Square computation may be of uncertain measure, which may be inconvenient for certain applications. So users might opt to tune the parameters of the procedure in order to reign in on this uncertainty. In some applications a trial and error method might prove useful. Trial And Error: Suppose Alice wishes to prove to Bob that she holds a secret, S, familiar to Bob. She might do so by sending him S²|_{c}. However, it may prove to be requiring a prohibitive number of additions. So Alice can stop the process at some point, and try again with another number. She will agree on some arbitrary AεZ⁺, and send Bob (S+A)²|_{c}. If this computation is proving too lengthy, she will try again with another value for A. A will be communicated to Bob so he can check if Alice really knows S.

### Tuning Examiner

A given specific implementation of a crypto-square algorithm may be examined as follows: First set up a range from a low value L to a high value H, both natural numbers. Second, randomly select n values within the set range: x₁, x₂, . . . xₙ. Third: square the selected values, and map the results on a range of square interest: L′ low value, to H′ high value. It's possible to set L=L′ and H=H′. Fourth: divide the range L′-H′ to t intervals, where t<<n. Fifth: build a histogram from the n squared results. Regard the number of squared results that fall into each interval as proportional to the chance for a random number to square into this interval. And based on these t probability values compute the relative entropy of the result as: Hr=H/log(t). (H being the standard Shannon Entropy). If the squared results divide very evenly on the range L′ to H′ then, Hr→1. The less even the results, the smaller the value of Hr. The value of Hr may serve as a tuning feedback. So one could, for instance, study how the relative entropy Hr behaves when the value of the complexity value, Cf, is changing: Hr=ƒ(Cf), and thereby select a ‘good’ Cf. The higher the value of n, the more representative the results. One could repeat this procedure with narrow intervals L-H (while leaving L′,H′ broad), and thereby find good and bad spots for the pre-squared values: small ranges where the squaring spreads nicely over a large range.

### Properties

The main property of the crypto square is that its domain and co-domain are both the infinite series of natural numbers. The crypto square is a proper function in as much as any natural number has a well defined square, but it is not a bijection in as much as any crypto-square has infinite natural numbers that square to it. So the full range of natural numbers is the image of the crypto square function. By allowing the domain to remain open ended, the full range of natural numbers, one guarantees an infinite number of solutions to the square-root equation, and thereby an infinity rated entropy measure. Since the infinity solution theorem is proven by construction, it leads to the derived theorem that for any Yε to Z⁺ there are infinite values X₁, X₂, . . . Xₙ that solve the equation: \sqrt{Y}=X²|_{c}. On the other hand, since the squaring of any number, X, has Z⁺ as its co-domain, then the probability that for any given a-priori AεZ⁺ we will have: A=X²|_{c} is infinitesimally low, and hence for any finite set of natural numbers, the chance that any member of the set will square to a given A is also negligible.

We address now two questions of interest: Given Y_{A}=(X+A)²|_{c} and Y_{B}=(X+B)²|_{c}, where A≠BεZ⁺, what is the X entropy? Both Y_{A} and Y_{B} range over Z⁺. So brute force examination will never be conclusive. The procedure itself seems to defy any analytic expression of the squaring algorithm, but if one is found then it would be possible to determine the measure of entropy, or equivocation. There may be none, one, few, or infinite solutions to the pair of equations as above. Of course if a given X, A, and B were used then there is at least one solution, but it is not clear how many more.

Proof of the Infinity Theorem:

Consider the equation: X=\sqrt{Y}|_{c}. We will solve it by first ‘subtracting’: finding a natural number, Q, such that: 2Q|_{c}=Y, or Q=2⁻²Y|_{c}. To do so we first make an arbitrary choice of whether 2Q|_{c} will be an encryption or a decryption. Suppose we decide it would be an encryption. Hence the 2⁻²Y|_{c} process will be a decryption. We will then construct an arbitrary valid Samid map subscribing to the rings rules (even rings full of ‘W’, odd rings marked with ‘X’, ‘Y’, and ‘Z’) [We use the single quote to differentiate between the X, Y, Z, W used in defining a Samid map, and the use of these characters elsewhere]. We now interpret Y as a bit string that lists by some order, map pathway directions: up, down, right, left. (U,D,R,L). The pathway, however long, fits into the size of the Samid map, whatever its size, and that is because of the infinity rules that dictate how to handle a pathway that seems to exceed the limits of the map. Having marked the pathway on the map, we can now use our choice letter markings on the squares of the map and deduce the corresponding plaintext, P. We have no restriction on how large the key, or the map may be. And once the size is determined we have a large variety (although not infinite) for letter-marking. The way the Samid cipher works is that not necessarily all the key structure is used for either encryption or decryption. And hence, even for back-designed decryption as we discuss now, and even for a limited size Y string to decrypt, it is possible to design an infinitely large key. Clearly so when we wish to construct a key for back-work encryption (where the crypto self-addition will be a decryption). The Samid cipher puts no restriction on how much larger the ciphertext is than the plaintext, so it can be of any desired size, using any desired large key. It is this attribute of the Samid cipher that insures that the back-work, or the solution of the crypto square root equation will have an infinity of solutions. As we discussed, if the back-work is encryption, then there is no doubt that the addition comprised of decryption will shrink into the plaintext Y. We do have an issue in the reverse because if the back-work operation was decryption then the addition that it reverses will be encryption, and encryption in the Samid design is one-to-many. We have shown with the ‘W’ string that we can add a string next to the plaintext P such that it would guide the encryption process to choose exactly the string that generated it, namely Y. We have also shown how to concatenate the W-string to the plaintext, so it can properly guide the encryption process. We have thus a proof by construction that the crypto square root equation has an infinite number of solutions.

Constructing Q:

We first concatenate the just produced plaintext, P, with the W bit string that was designed to guide the crypto self addition process to encrypt exactly Y and no other. Of course, if the self-addition is selected to decryption, then there is no W string. We mark this concatenation as ‘P-W’. We now further concatenate with K, which is the key-string that corresponds to the Samid map that we engineered to decrypt Y to P. This creates a concatenated string P-W-K, where |P|=p is the bit count of the decrypted result, P, w=|W| is the bit count of the W string, and |K|=k is the string expression of the Samid map.

We now solve the following: identifying the number of bits t to be used to indicate the breakup of P-W-K to P-W and K. We are looking for the smallest t such that:

2^{t}≧p+w+k−pc_{threshold}−k_{threshold}

and identify the bit string T for which the numeric value will be:

T=p+w−pc_{threshold}

Now we construct a bit string of length t bits, T*, which evaluates to T (hence we might have to add a necessary number of zeros to the left of the number).

We finally concatenate T* to the left of P-W-K to build T*-P-W-K. So done we now need to add 2 bits, one rightmost and the other leftmost, so that their XORed value will indicate encryption, or decryption, as the next step. The string:

Q={1 bit}-T*-P-W-K-{1-bit}

Note: We mark the W-string for both the case where the self addition is encryption or decryption. Clearly if it is decryption the W-string vanishes, or say its length w=0.

We can now assert: Q=2⁻²Y. This is so because we have traced back the crypto addition, to insure that the result achieved, Q, will be crypto self-added to Y. We can see it clearly: to compute 2W|_{c}, one will first XOR the rightmost and leftmost bits, to identify the process as encryption or decryption. Since we added these two bits, their message will fit our design. These two bits are then ignored. One will then look for the value oft bits to indicate the breakup of the rest of the string to P-W and K. Based on the construction of this substring, one will identify the same number t that we used to add the T* substring. Evaluating the value of this substring, T, one will divide the P-W-K substring exactly the way it was originally concatenated to ‘P-W’ and K. The next step in the crypto self-addition process would be to construct the Samid map, which one will do using in reverse the same rules that were used to build this string from the map used in the back-work. Therefore the resultant map will be the one that was used in processing of the reverse-addition equation (Y Q). If the map is the one that was used in the decryption process before, then if the rules of resolving encryption choices are applied (per the W string) then the resultant ciphertext will be exactly Y, which proves that the computed W adds up to Y. Taking note that the back-work key, and the reverse-generated plaintext were arbitrarily selected, and that there are infinitely many choices for keys and plaintexts, one concludes that there are infinite solutions to the reverse-addition (subtraction) equation. And since the Crypto Square is essentially a finite series of additions, it also follows that the Crypto Square has infinite solutions. It is worthwhile to remember that the key can be constructed to affect a plaintext much much smaller than the ciphertext. Especially in higher up rings. Note that ring number n, will be comprised of 8n squares, and in each ring one could find long sequences of same letter. Such sequences might correspond to a plaintext much smaller than the ciphertext. We have presented very specific procedures that can take any arbitrary natural number, Y, and back-work from it an infinite number of natural numbers X₁, X₂, . . . that will all Crypto-Square into Y, given the definition of crypto squaring. This cardinal fact serves to protect the identity of the particular natural number X that was used to crypto-square it to Y. This protection by equivocation is immunized against some future or unknown mathematical insight, and this very fact keeps our interest focused on this concept.

### Use

Being an unbreakable one-way function the crypto square stands to assume quite a few roles in important crypto protocols. One main use of the Crypto Square involves confirmation of mutual knowledge. Suppose Alice and Bob wish to confirm that they both hold on to the same shared secret, M. Yet, other than this suspected secret they have no shared secret data. So Alice cannot use a secret key to encrypt M, for Bob to verify that it's the same M he is holding to. Alice, in general, could use any acceptable one-way function like raising a given A by M mod some number N. Bob will do the same and thereby they will confirm their shared secret. So doing keeps Alice and Bob vulnerable to Eve who might have found a mathematical shortcut to exercise the modular logarithmic computation, and derive M. Eve might use a generic computational formula, or a specific formula good for some special cases which Alice's choice happens to be one of them. This is especially important if Eve is a world class crypto organization and if the secret Alice and Bob share has a long life span.

In that case, Alice and Bob can use the crypto square as an unbreakable one-way function. As discussed in the properties section, if they agree on the same crypto result they should be quite confident that there is little chance for collision, namely that while they both agree on the same M²|_{c}, their M values are different, and at the same time, Eve will have to list an infinite number of candidates to deduce M from, which makes it impossible for her. Another use involves identity verification. Alice wishes to ascertain that the one who claims to be Bob is indeed Bob. She has Bob's secret identifier, b. She would then develop some random number A and challenge Bob to square (b+A)²|_{c}. If he computes right, he knows b—no doubt it. In the next session Alice will challenge Bob with A′ to compute: (b+A′)²|_{c}. She will then check again. Eve will have a hard time to make a list of all values that fit both squares in order to find, hopefully the one value of b that would fit both computations. Alice could apply the same trick with a new random shift number some k times, and although the larger the value of k, the greater the chance that there will be only one value to satisfy all the squares, because for each square there are infinite number of options, Eve will find it intractable to spot this one value. Of course Bob can ascertain Alice's identity in a symmetric fashion. Key Management: The Crypto-Square could be used to facilitate key management in several ways: (1) identity based encryption, (2) key hierarchy.

Identity Based Encryption:

Alice and Bob communicated with a center, each with his or her own key: Kₐ and K_{b}. Originally Alice and Bob give the center some personal id data, Pₐ, and P_{b}, and the center, relying on a ‘deep secret’ S, computes: Kₐ=(S+Pₐ)²|_{c}, K_{b}=(S+P_{b})²|_{c}, and safely communicates the keys to their owners. The center does not need to maintain a database of these keys, so they cannot be stolen. Instead, when Alice or Bob communicate with the center they first identify themselves with Pₐ and P_{b}, so that the center can regenerate Kₐ and K_{b}, as before, based on S.

Key Hierarchy:

A deeps secret S may generate a first echelon of high level keys:

K₁₁=(S+P₁)²|_{c}, K₁₂=(S+P₂)²|_{c}, . . .

To be attributed to departments 1 and 2 identified by their private data P₁ and P₂ respectively. Each department could allocate crypto keys to its sections using the private identification of these sections. So department 1 will build a key for its section (a):

K₁₁ₐ=(K₁₁+P₁ₐ)²|_{c}

without knowing deep secret S. And so on, the sections will allocate keys down to subsections, and they to individuals, etc. Each echelon will build it down using the Crypto Square, without visibility to the generating key of the higher echelon. It's noteworthy that the keys are backward protected. Namely if a derived key is compromised, the key that generated it in a squaring process remains shielded by the equivocation principle.

Communicating Squared Results:

Since the squared results may be of surprise size, it may be necessary for certain protocols to hash the results to a fixed size. This can be done by compromising some of the advantages of raw squaring, and so optimization may be in order.

### On the Possibility of Attaining Privacy Despite Prying Comprehensive Observation

Abstract:

In order to secure the benefit of cooperation, parties need to mutually communicate their intentions. If the parties are subject to hostile observation then their communication might help their hostile observer to harm them. This leads to the question: can parties establish a measure of group privacy and deny their hostile observer the benefit of reading their communicated plans and intentions?

This question is relevant to people, computing nodes, biological entities, and pre-life cooperation. The answer may provide insight to issues of society, and culture, evolution, and computer security. It appears that bilateral privacy, BP, towards a comprehensive observer may be unachievable in a pure and absolute sense, but simple procedures will allow two fully exposed parties achieve a bilateral privacy advantage sufficient for their needs. The parties will express this advantage in the form of a bilateral language that provides for communication towards cooperation, while insuring a cryptic defense towards their hostile observer. One such procedure is based on the “birthday principle”: the parties, each selects a small random subset of items from a large exposed set. Then they engage in a dialogue designed to mutually point them to the likely same item they have selected. The hostile observer exploits this dialogue to narrow down its list of candidates for the shared item (shared secret, the match), but its entropy of the situation remains higher than that of the parties, and this entropic advantage over sufficient span of time provides the parties with the privacy they seek. It appears that if two communicating parties would put up with a tolerable level of uncertainty in their communication, they will be able to keep their observer mired in much greater terminal uncertainty as to their exchange. Alternatively, they could communicate with certainty, and establish a sufficient time delay for their observer to catch up. Once the parties establish such a knowledge-edge over their observer, they can leverage it into greater privacy through reiteration of the original procedure.

In a Darwinian setting, privacy establishing procedures may be regarded as survival tools, and hence, will be added to the toolbox of the descendants, and be enhanced generationally.

### Introduction

The challenge to cooperate and communicate under hostile exposure manifests itself in various settings. We see it in nature, where one asks what role does this challenge play in the process of evolution; we see it in war, competition, sports and in many games; we identify this challenge in cultural and social processes; we may even spot it in biochemical activities, with chemical secrets. Lately such a challenge manifests itself between two strangers on the Internet who wish to establish a bilateral privacy under so many prying eyes. In contemplating this challenge of privacy under hostile exposure one first asks: is it theoretically possible? If two parties have all their communications exposed to a hostile observer, how can they achieve a bilateral knowledge that will never be compromised by their observer? The conjectured answer to this theoretical question is that indeed they can't, as we shall attempt to prove ahead. Having so noted, we may come to ask a less theoretical, and more practical question: can these two parties secure a knowledge-advantage over their hostile observer? Is it possible that while it matters, the parties will have a piece of knowledge that is not yet known to their observer? Here the answer is yes, it is possible. Communicating Parties can establish a desired measure of privacy protection for as long as they care. And we shall show a set of procedures to achieve that. The next question of interest is: are those privacy securing procedures simple enough to be practiced by “communicating parties” with a limited communication vocabulary? The answer is again in the affirmative. This is quite exciting because it suggests that by process of random tries, and evolution, some very primitive entities could have secured bilateral and group privacy under hostile observation. In the basic setting we talk about bilateral privacy, but it may readily be extended to multi-lateral privacy, and create groups who communicate with a private language, not shared by their observers. The principles of modern evolution dictate that groups who successfully denied their hostile observer critical information to harm them with, are more likely to proliferate, and hence secure languages may evolve alongside the more traditional aspect of Darwinian evolution. The same principle may be extended to social behavior, explaining dialects, jargon, and other differentials of language. In this short article we simply state the premise and provide some rudimentary formalism to express it. Since this concept emerged from cryptographic research, we shall designate the two communicating parties as Alice and Bob—the traditional crypto couple, and refer to their comprehensive observer as Eve—the eavesdropper. It has been established for quite some time now that Alice and Bob, two strangers on the Internet, may establish a private channel resistant to Eve's prying eyes. The methods used by Alice and Bob over the Internet involved mathematical complexity and hence the application of these methods was deemed limited to parties who are cognizant of such complex mathematics. It was only when research has discovered that such privacy under complete exposure can also be attained using very simple operations, that it came to mind that this practice could have been used by any communicating parties regardless of their sophistication.

### Theoretical Foundation

We describe the Privacy under hostile observation challenge first by introducing the ‘basic setting’.

Basic Setting:

Alice and Bob are two communicating parties trying to establish privacy between them. Eve is a hostile prying party that has access and visibility to any and all of the communication between Alice and Bob, and her aim is to deny Alice and Bob any privacy, or, say, to be in the know of everything Alice and Bob are planning, or saying to each other. Our goal is to find ways for Alice and Bob to establish their desired privacy, and keep Eve ignorant about it.

One Secret is Enough:

Let's suppose that Alice and Bob have secured a single natural number as a private secret unknown to Eve. We will show that this single number can be leveraged to build a full fledged secret language to serve Alice and Bob for their needs, while keeping Eve totally in the dark, unable to decipher that private language. This fact reduces the aim for privacy to the goal of developing just one secret number because it can readily become a seed for a full private language.

Crypto Square: A Method to Leverage a Single Secret Natural Number to a Larger Secret.

Let M be a secret natural number known only to Alice and Bob, and of which Eve is totally ignorant. By “totally ignorant” we mean that Eve has no knowledge even of the size of M. Using Crypto-Square both Alice and Bob will compute the ‘square’ of M: M′=M²|_{c} and use it as an additional secret. They can repeat the process to compute M″=M′²|_{c}=M⁴|_{c} and so on, keep squaring the results and generate more and more secrets which can accumulate to a secret language. Alternatively, Alice and Bob may develop a language that is comprised of n words: W₁, W₂, . . . Wₙ. They will agree in the open to communicate any statement in that language by encrypting every one of its n words via the expression: W′ᵢ=(M+Wᵢ)²|_{c} Eve will know that each W′ᵢ represents one of the {W}ₙ words in the language, but will not know which. This scheme can be made more robust by adding an arbitrary number, R, that can be changed by some rule: W′ᵢ=(M+R+Wᵢ)²|_{c} Of course, Alice and Bob can replace the addition with some other function W′ᵢ=(ƒ(M, R, Wᵢ))²|_{c} The unbreakability of the Crypto Square will guarantee the secrecy of the additional information—based on the initial secrecy of M. There are various other means to expand a small secret M to a larger one, and thus support a rich vocabulary of communication and cooperation, all secured from the prying eyes of Eve. The conclusion from this is that a single secret natural number is all that Alice and Bob will require for their robust privacy against Eve. Securing a Single Secret: Focusing now on means to secure a single secret M, we may define a “Selection Space” S that includes all the possible M values Alice and Bob could come up with. Once S is defined, then the chance for Eve to guess the value of M will be 1/|S|=1/s, where |S|=s is the size of S, or say, the number of possible M values. The larger the value of s, the greater the security of Alice and Bob against prying Eve. Theoretical Impossibility: What we may learn from the above is that if Alice and Bob enter into the “public domain” where Eve is watching them, after they have previously secured an unassailable shared secret M, then they can communicate security fending off Eve. However, it is easy to show that it would be impossible for Alice and Bob to conduct a conversation open to Eve, and thereby secure a secret M, which Eve will never identify. Suppose Alice and Bob exercised some open information exchange (and having no private exchange beforehand), in which they secured a private shared number M. That exchange could obviously not mention M in the open, since Eve is listening and would also know it. We must therefore conclude that Alice and Bob exchanged some information that convinced both of them that they each have the same matching value of M in mind. In other words, if Mₐ is the value Alice deems to be the match, M, and M_{b} is the value Bob evaluates to be the match M, then their dialogue Δ, would convince both of them that Mₐ=M_{b}=M. Such certainty implies that there is no possibility that another member of S, M′ is in fact M′=Mₐ, while M=M_{b}≠M′. But Eve had access to the very same information that Alice passed to Bob to convince him that they have a match, (and to any information Bob passed to Alice for the same purpose), so she too would be in a position to conclude the identity of M=Mₐ=Mₑ (the eve match candidate), and mark off any other element of S as that candidate. If Eve had any suspicion or would have to conclude that there is any chance, small as it may be (but not zero), for the matching candidate to be Mₑ=M′, then M′ could also have passed by Bob as Mₐ—again, since he deduces from the same information. In other words, total certainty, or say zero entropy for Bob in deducing the match M (and symmetrically for Alice) implies total certainty for Eve determining the same fact. Eve may face more computation, more analysis, more work, but by the end of the day, if Bob knows the match based on his public conversation with Alice, in full certainty, so does Eve. So, do we close the books on this challenge and go home? Not at all.

Practical Possibility:

The above rationale holds only for the case where both Alice and Bob have no doubt whatsoever regarding their shared match—shared secret. Only in that case, where the Shannon entropy computed by each of them, Hₐ and H_{b} respectively are both zero: Hₐ=H_{b}=0 do we conclude that by the end of the day, after perhaps more computing, Eve's entropy will be the same: Hₐ=H_{b}=Hₑ=0. This rational fails for the case where the entropy expression computed by Alice and Bob regarding their match is however slightly above zero: Hₐ, H_{b}>0. In that case we will have Hₑ>0 too, and in some well designed cases we will have:

Hₑ>>Hₐ, H_{b}>0.

And that difference:

BP(t→∞)=Hₑ(t→∞)−H_{ab}⁺(t→∞)∀H_{ab}+>0

is the Bilateral Privacy, BP, at t→∞. Here we use the following expressions:

H_{ab}⁺={Hₐ,H_{b}}ₘₐₓ

H_{ab}⁻={Hₐ,H_{b}}ₘᵢₙ

A subtle point deserves mentioning: If Alice and Bob continue indefinitely to use their privacy, they eventually lose any measure of equivocation, since their secret works for them. And similarly, they keep providing Eve with inferencial raw material to break their privacy with. So any established fixed privacy will so remain, only if its use is frozen at some point (and, say, a newly established privacy is used). If Alice and Bob keep using the same secret, they will eventually lose their entropic advantage. But then again, every secret, every privacy, has its useful life-time, and should be kept as privacy only during its usefulness period.

In other words, while it is impossible for Alice and Bob to secure with certainty a bilateral secret based on open information exchange, there is no theoretical impediment for them to achieve an entropic advantage over Eve, namely to determine a match—a joint secret—at sufficiently high certainty (but not absolute), and thereby impose a sufficiently low certainty on Eve with respect to the same piece of data—the match. It is this certainty advantage, referred to as entropic advantage that serves as the nagging temptation to seek and identify a fitting procedure that would implement this advantage, and put it for good use, to allow Alice and Bob to establish their desired security.

We can simplify the entropic calculations through “binarization” of the probability function. In the full fledged Shannon entropic expression one considers the probability range 0-1 for any S element to be the target match. In a simpler view every candidate is either in the ‘eligible’ list, or in the ‘marked off’ list, namely the probability to be a match is either zero for all the “marked off” candidates, or 1/e for each and every candidate in the “equivocation list”—the list of the elements of S that have not been marked off, and e is their count. Accordingly, the entropy of the situation is expressed as log(e). Each of the parties: Alice, Bob, and Eve are associated with their equivocation number: eₐ, e_{b}, and e_{c}. For simplicity of notation we will normally interpret e=eₑ.

So the BP can also be expressed as BP=log(e)−{log(eₐ), log(e_{b})}ₘₐₓ, or in equivocation count: e−{eₐ, e_{b}}ₘₐₓ. We shall also refer to the equivocation lists as match-lists: they are the lists from where to expect the match. This basic setting has Alice, Bob, and Eve facing a selection set S, from which Alice and Bob desire to point to an element (called “the match”) such that its identity would not be known to Eve (but known to both Alice and Bob) and where, to begin with, all the elements are rated equal, per likelihood to be the “match”. And then Alice and Bob exercise a certain procedure exposed to Eve and as this procedure progresses Alice and Bob shrink their equivocation list from s to 1, or close to it, (and thereby both agree on a match), while Eve faces a larger equivocation list, and hence faces greater uncertainty as to the identity of the match.

The Affinity Function Upgrade:

The basic setting had Alice and Bob neutrally disposed towards the selection of the match—each element of S had the same chance to be selected. This assumption may be dropped and replaced with the selection affinity concept. Affinity may be expressed by associating each communicating party with an affinity function over the s elements in S. The function ƒ will be defined over the 1, 2, . . . , i, . . . s elements in S: ƒ(i), such that for two element i,jεS, if ƒ(i)>ƒ(j) then the likelihood that that party will pick i as a match candidate is higher than the likelihood for same party to pick element j. We can agree that ƒ is normalized such that Σᵢ₌₁^{i=s}ƒ(i)=1 The cases described so far (the basic setting) exhibited flat affinity, all elements have the same likelihood to be selected as a party's match candidate: ƒ(i)=1/s for i=1, 2, . . . s. One could envision a situation where Alice and Bob share some disposition expressed as a similar affinity function. This function will allow certain members of S to be more likely than others for selection for the picked match. If Alice and Bob share a similar affinity function then their chances to have a match per same size of match-list drawn independently, is increased, and to the extent that their affinity function is invisible to Eve, and not shared by her, then this will allow for a greater entropic advantage. Allowing for the affinity function one could write:

Hₐ(t=0)=−Σᵢ₌₁^{i=s}(ƒₐ(i)*log(ƒₐ(i)))

H_{b}(t=0)=−Σᵢ₌₁^{i=s}(ƒ_{b}(i)*log(ƒ_{b}(i)))

Hₑ(t=0)=−Σᵢ₌₁^{i=s}(ƒₑ(i)*log(ƒₑ(i)))

If ƒₐ=ƒ_{b}=ƒₑ then the affinity advantage cancels out. If ƒₐ=ƒ_{b}≠ƒₑ then Alice and Bob are more likely to find a match keeping a greater entropic advantage over Eve.

### Principles of Operation

The principles of operation for achieving the bilateral privacy are: (i) Alice and Bob initiate dialogues aimed at reaching a jointly pointed-to match—an element M in a selection set S (comprised of s elements). As the dialogue proceeds, it provides more information for both Alice and Bob to zero in on, and find their match. Eve uses the same dialogues to find the very same match. Albeit, the dialogues are designed to impose an entropic advantage in favor of Alice and Bob. They then exploit this advantage in subsequent ways to create practical privacy against Eve. Using Shannon's entropy the initial entropic expressions for Alice, Bob, and Eve is:

$${H}_{α} ( t = 0 ) = {H}_{b} ( t = 0 ) = {H}_{e} ( t = 0 ) = - {\sum }_{i = 1}^{i = s} {p}_{i} log ( {p}_{i} ) = - s ( \frac{1}{s} ) log ( \frac{1}{s} ) = log ( s )$$

$${H}_{a} ( t \to ∞ ) = {H}_{b} ( t \to ∞ ) = {H}_{e} ( t \to ∞ ) = 0$$

The effect of Alice-Bob dialogues is the reduction of the three entropic expressions over time:

$$\frac{d {H}_{a}}{d t} < 0 ; \frac{d {H}_{b}}{d t} < 0 ; \frac{d {H}_{e}}{d t} < 0$$

zee moleskin g2708 ziur See FIG. 3. And the absolute bilateral privacy advantage is defined between two time points t₁ and t₂ as:

$${BPA}_{absolute} = {\int }_{t 1}^{t 2} ( {H}_{e} ( t ) - {H}_{ab}^{+} ( t ) ) d t$$

The above entropic expression refers to the maximum knowledge assumed by each of the three parties, based on what each is aware of at time point t. This entropy is generally less than what these parties actually conclude at time point t since there is a time lag between the moment a party is exposed to an information exchange between Alice and Bob, and the moment that party exploits it to its fullest conclusion potential. The more efficient the computing machines for each party, the smaller that time leg. We will denote as H′(t) the actual deduced knowledge at time t, which is generally smaller than H(t) for the same party. So we may define the actual bilateral advantage between two time points t₁ and t₂ as:

BPA_{actual}=∫ₜ₁^{t2}(H′ₑ(t)=H′⁺_{ab}(t))dt

This BPA may be exploited by Alice and Bob in several different ways and their combinations:
iterative enhancement of privacy
exchanging private information
maneuvering towards a private setting
expanding to multi-lateral privacy

The “dialogues” between Alice and Bob may take several forms:
Mutual effort to agree on a match
Verification of the presumed match candidates
exploitation of the match candidate.

The Dialogues Between Alice and Bob:

The “dialogues” between Alice and Bob may take several forms:
Mutual effort to agree on a match
Verification of the presumed match candidates
exploitation of the match candidate.

It is important to note that any part of the dialogues is raw inference material for Eve to help her shrink her entropy for the identity of the match.

|>Mutual Agreement on a Match:

These are conversations between Alice and Bob designed to reduce their entropic expression with respect to a shared match, eliminate as many as possible elements from S—as candidates, and increase the probability of one or few as the target match. By its very nature this exchange must refer to the target match by some of its properties, and not by its name or identification, since the latter will be readily picked up by Eve, and any knowledge advantage will be instantly wiped off.

We set forth some reasonable principles for the match-finding dialogues:
symmetry
property calculus
randomization.

Symmetry:

Alice and Bob should act in perfect symmetry one towards the other. Any question initiated by Alice, should also be initiated by Bob, and same for responses. This will share the computation work load between the cooperating parties. Note: computational symmetry, should reflect any computational imbalance. If Alice has a more powerful computing power, she can do more than Bob.

Properties Calculus:

Alice and Bob may wish to refer to the various elements in the selection space S by computing and communicating some of their properties. These properties should characterize the elements but not uniquely identify them. That means Alice and Bob should select properties such that sufficient number of elements in S share the same value for each selected property. For example, an element, r, in S may be described by its property-i value: rᵢ. If there are t elements in S with i value of rᵢ, then Eve will eventually narrow down her candidate list to these t. But to no further. And if at that stage Bob has narrowed down his list to β<s elements then his equivocation, on average might be: t*(β/s), so that in that move Bob has developed an entropic advantage over Eve (BPA=t(1|β/s). Of course, if no other element in S would have shared the value rᵢ, then both Eve and Bob would know for sure the identity of the match; Bob would find out earlier though, if both him and Eve use comparables computing machines. Alice might continue reporting the value of another property, say, j, and convey rⱼ to Bob. Now Bob knows that Alice refers to an element with i property value of rᵢ and j value of rⱼ and his list narrows down. At the same time Eve also narrows her list to the only S elements with values rᵢ and rⱼ, but her list is likely to be longer and thereby the bilateral privacy advantage is created. Randomization: Randomization is a powerful cryptographic tool. Both Alice and Bob have the option to select any number of elements from S in a random fashion, so that Eve would not be able to predict the selection. Different size selections have different well expected properties. Of particular interest is the non-intuitive probability calculus result that specifies that Alice and Bob may independently randomly select nₐ and n_{b} elements respectively, and associate their picks with a probability rating, Pr, to have happened to select a match—the same element in their randomly picked elements. The value of this probability is completely dependent on the values of s, nₐ, and n_{b}:

Pr(match)=ƒ(s,nₐ,n_{b})

A strong expectation to hold a match within a small subset of S is a basis for ongoing dialogue to flush out this match without timely disclosing its identity to Eve.

|>Verification of Match Identity:

Having concluded the match identification dialogue, Alice and Bob may wish to verify their find, and do so without disclosing its identity to Eve. Two verification concepts are presented:
random-plaintext encryption
one-way function

In random-plaintext encryption Alice uses her match candidate Mₐ as a cryptographic key over an agreed upon verification cipher, and encrypts a random plaintext sequence, Pₐ, which she communicates to Bob. Bob uses his match candidate M_{b} and decrypt Alice's cipher to his version of the plaintext, P_{b}. If Alice finds that Pₐ=P_{b} then she signals to Bob that they indeed have a verified match. If Pₐ≠P_{b} then she signals that they don't have a match. The problem of course is that given the pair ciphertext/plaintext Eve can run all her candidates until she finds the match. In that case Alice and Bob will only benefit from the extra time it would take Eve to check all her candidates. The one-way function solution is based on agreeing on a one-way function and processing the match candidate with it. Both Alice and Bob publish the result of the same one-way function process, and if these results agree, they consider the match candidates verified: M=Mₐ=M_{b}. For example, Alice and Bob can use the Crypto-Square to force Eve to use only brute force to crack the secret M (and not any surprise mathematical shortcut). Both verification methods may be practiced straight on, or may be enhanced:
The sub-string disclosure method
The super-string confusion method.

The Sub-String Disclosure Method:

Using either verification method, Alice and Bob may choose to expose only a sub-string of their computed result. Suppose Alice computed Mₐ²|_{c}, but instead of publishing it in the entirety so that Bob can compare it to his computation of M_{b}²|_{c}, Alice communicates to Bob only a substring of size g bits (or a hash of g bits size). If Bob finds the g string in his computed result then he says so to Alice, and the two have thereby established an increased measure of confidence that they both point to the same match candidate. If the complete string of the crypto square is |g*| bits long then the pair (g, g*) completely defines the chances for a random string of length |g*| bits to contain a substring communicated by Alice—of length g bits. This is the probability of error, Pₑᵣᵣ. Eve, on her part is looking at e elements in her equivocation list, and hence this verification dialogue between Alice and Bob is likely to reduce e into e′=e*Pₑᵣᵣ. So the price of increased confidence for Alice and Bob to actually have agreed on the same match is to further reduce the Eve's equivocation list. If |g|→|g*|, then the confidence level approaches certainty, but Eve's equivocation is virtually disappearing. A similar situation happens with the random-plaintext method. Alice publishes the ciphertext, and Bob in return publishes a substring of his computed plaintext. The super-string confusion method is designed to increase Eve's workload. Instead of communicating the ciphertext in the random-plaintext method, say of length c bits, Alice communicates kc bits to Bob. Bob then decrypts the k c-bits long strings, and Alice checks if any of Bob's decryptions matches her plaintext. Since Eve has to try her entire equivocation list, this method multiplies her workload by a factor of k. Bob on his part, may embed his computed plaintext (which he sends back to Alice), of say p bits long within a larger bit sequence of k′p long bits. Alice simply scans the k′p bits string to see if the expected plaintext string is there. Eve will have regard each of the (k′−1)p strings Bob communicated as the right plaintext with respect to each of the kc ciphertext options in the string that Alice sent, this would mean a workload increase by a factor of k(k′−1) for Eve. Since Alice and Bob have full control over the values of p, c, k, and k′ they can determine how much extra work Eve will have to contend with. Here the end entropy computed by Eve is the same, only the time delay is different.

|>Exploitation of the Match Candidate:

Let Alice and Bob start their privacy effort at time point t₀. At time point t₁ they have concluded their match-identification dialogue as well as any verification dialogue they chose to practice. Now is the time for them to harvest the fruits of their effort, to exploit the privacy they have secured. In principle there are two courses of action available to them:
apply a payload
leverage the privacy

Applicable separately or in combination.

Applying a Payload:

Alice and Bob are building a privacy protection for themselves in order to be able to exchange information and knowledge without it being exposed to Eve. The information they exchange is regarded as payload. They could use the secret match they have secured as a cryptographic key of some sort, and apply it to encrypt their information exchange. While they do so Eve is busy pushing her respective entropy down, and identifying the secret match so that she can spy and pry on Alice and Bob and expose their payload. Since in general the use of the payload is regarded as inferential raw material for Eve, one must assume that after sufficient time Eve will zero out her entropy, or, say, reduce her equivocation list to a single element of S, and wipe out any privacy defense built by Alice and Bob. We have argued before that there is a theoretical possibility for the dialogue to be of sufficiently restricted measure for Eve to remain with a residual equivocation she will never be able to resolve, but for our discussion here, it is safer to assume that a time will come and all secrecy of Alice and Bob versus Eve has in fact vanished. This picture brings to the fore the notion of the “life time of the communication payload”, or in other words: how long should a given payload remain private? The lifetime of payload may vary according to the nature of the payload and the actual circumstances. Some secrets are short lived, others live a long time. At any rate Alice and Bob are in a perfect position to appraise the lifetime of their exchanged payload. What is more, and quite important, is the fact that Alice and Bob are in a perfect position to appraise the entropy advantage they have over Eve. They can play the role of Eve, they know all that Eve knows, and can accurately appraise Eve's equivocation, e. If we further assume that Alice and Bob have a good estimate of Eve's computing capabilities then we may conclude that Alice and Bob for any instance of this Bilateral Privacy (BP) procedure can accurately and reliably estimate how long will it take Eve to wipe out the privacy defense they have just constructed against her. In the case where Alice and Bob estimate the life time of their payload X (Xₜ) to be shorter than their estimate of the durability of their privacy (Eqₜ—the time for Eve to go through her equivocation list, e), they can safely apply the payload, and successfully conclude this session of BP. In the case where Eqₜ<xₜ it would not be safe to apply the payload because it would be exposed while it is still ‘hot’ and its exposure will be harmful to Alice and Bob. In that case Alice and Bob will have to turn to the other exploitation option, and that is to leverage the privacy achieved thus far to a higher measure of privacy with a higher Eqₜ value so that their privacy would last through the xₜ. In general, to leverage the privacy means to re-apply the same (or similar) procedure used to construct the first round of privacy. The second round may be practiced over data that is not exposed as in the first round, but rather encrypted with the privacy achieved before. Alice and Bob will choose a method designed to modify the data that comprises the selection space, and any associated data they have used in their match-finding dialogue. If they repeat the same procedure they will yield the same entropic advantage that they achieved the first time around. If Eve ended up with an equivocation list of e elements in S, the first time around, then she would end up with e the second time around (e is rated per Eve's knowledge when the secret sharing round is concluded). Alas, Eve would have to try every element in her first list as the one used by Alice and Bob to encrypt the data over which they used the BP procedure the second time around, that means that Eve will face a maximum equivocation measure of e².

Alice and Bob can readily re-apply the same procedure with the newly developed privacy from the second round to achieve maximum privacy rated e³ in the third round, and in general maximum privacy e^{t} in the t round. At some value of t Eqₜ will be higher than Xₜ. And then Alice and Bob would be ready to apply the payload (Xₜ). In practice Alice and Bob calculation will have to account for the time T_{ab} it takes them to exercise a match-finding round, since Eve would use that time to reduce her equivocation measure, e by a measure proportional to T_{ab}. So that the de-facto equivocation shield enjoyed by Alice and Bob after t rounds is:

e_{shield}(t)=(e−εT_{ab})^{t}

where ε is a proportional factor reflecting Eve's inferential success while Alice and Bob exercise the next round. In a more general case Alice and Bob will have various payloads to engage, each with its own lifetime. They will then be able to apply each payload at the point where the prevailing privacy is of sufficient measure, and wait for the more durable payloads until their re-application of the BP procedure produces the required privacy to outlast the payload lifetime.

Exploiting the Bilateral Privacy Advantage:

This BPA may be exploited by Alice and Bob in several different ways and their combinations:
iterative enhancement of privacy
exchanging private information
maneuvering towards a private setting
expanding to multi-lateral privacy

The iterative enhancement of privacy was discussed as part of the dialogues, same for the exchange of private information (payload). The third option refers to using the privacy to coordinate action that would maneuver Alice and Bob to a setting where Eve loses its prying ability, and it is safe then to exchange private information.

Expanding to Multi-Lateral Privacy.

Let Carla and David do as Alice and Bob—establishing their bilateral privacy. So done, Alice and Carla could go through the same exercise. This will allow Alice, Bob, Carla, and David to share privacy, and similarly to expand this sharing with another group of four communication partners. The now eight-fold secret sharing group will have Alice, and Zoe from another 8-group of secret sharing parties, establish bilateral privacy which will then be extended to 16 secret sharing parties, and so on to any desired size of a secret sharing group.

The Birthday solution: see ahead.

### Utilizing the Affinity Function

The affinity function can be native to Alice and Bob and imply better and faster private communication between them. But affinity can also be introduced as part of the communication pattern between Alice and Bob. Of particular interest is the case where Alice and Bob use the first round shared secret—the first match, as an input to an algorithm that affects their respective affinity functions. Since they use the same shared secrets, their next round affinity functions will look similar, and they both will be likely to pick the elements of S for which the selection affinity is higher. That means that they will likely net more matches the next round, if they keep the same size picking subset (match list). By repeating the re-shaping of the affinity function each round, they will increase the number of matches, and then re-shape the affinity function further. In the extreme case the affinity function of Alice and Bob will be ƒₐ(i=m)=1, and ƒₐ(i≠m)=δ, and ƒ_{b}(i=m)=1 and ƒ_{b}(i≠m)=δ (some infinitesimally small number), so both Alice and Bob when they pick n elements the next time around they will both pick m and (n−1) others. By repeating this exercise sufficient number of times they will both realize that they have m each time, and so minimize their respective entropy functions as close to zero as they care. Eve, on the other hand, will not know which elements Alice and Bob picked each time, and she would surely not know the shape of the their similar affinity function. However, Eve will notice that Alice and Bob keep running the BP procedure, each time with n elements. And if Alice and Bob repeat too many time the terminal case, m, as described above, then Eve will eventually notice that one particular element keeps showing up in her equivocation list for each round, and rightly suspect this element to be the match. One important advantage of this re-enhancement of similar affinity procedure is that it can be applied with Alice and Bob, both holding on to a small number of matching candidates. All the prospective matches may be combined into a single input that re-shapes the affinity function. If Alice and Bob don't have a completely congruent list then no harm is done, they would simply have a somewhat less similar affinity function, and not as many shared picks the next time around. The use of a former round secret to re-shape the affinity function is very fault tolerant. Its progress may be slow. In other words: using an established temporary secret to re-shape the affinity function will help Alice and Bob generate a match the next time around while keeping Eve in the dark because the affinity function is not exposed only its outcome, the respective picks of Alice and Bob are the manifestation of the re-shaped affinity function. Alice and Bob may choose to put up with a measure of uncertainty (a threshold entropy H_{ab}⁺) to insure that Eve is plagued by much higher uncertainty, (higher H_{c}). Then use the not-so-sure shared secret to modify the affinity function, and increase the chances for a match next time around.

There are many ways to modify the affinity function. Suppose Alice picked n elements from the selection set S: A₁, A₂, . . . Aₙ, and Bob also picked n elements from S: B₁, B₂, . . . Bₙ. Alice and Bob then exchange information regarding their picks and as a result Alice marked off some of her pickings and was left with A₁, A₂, . . . Aₘ candidates, while Bob, respectively was left with B₁, B₂, . . . Bₘ candidates. (We can, for convenience suppose that m value is the same for Alice and Bob, although it does not have to be that way.). Alice and Bob may choose not to continue with the dialogue that would reduce the value of m, and thereby admit a relatively high entropy as to their match, but also insure that Eve's uncertainty is much higher. Then Alice and Bob will each independently use their survivor's list to modify the affinity function for the next time. For example Alice affinity function for element rᵢ, i=1, 2, . . . s might be set to be:

ƒ_{A}(i)=k(1−Πⱼ₌₁^{j=m}(Aⱼ−rᵢ))

where k is a factor to be adjusted such that Σ₁^{s}ƒ=1. And Bob will use a similar formula to compute ƒ_{B}(i). This will offer a great likelihood that the surviving list will be re-picked, plus some (n−m) new elements. The affinity function will not be exposed to Eve, and Alice and Bob will not know whether they work from the same affinity function, but it is likely that their respective affinity functions increase their chance to find a match the next time around. They may exploit this greater chance for a match in their subsequent dialogue, or they may reduce the size of n.

### Applications

It is easy to see how a sophisticated Alice and Bob will apply this BP tool. But it is particularly intriguing to explore the possibility for Alice and Bob to be non-self cognizant, simpletons who develop and enhance a BP capability through trial and error, possibly enhanced by cross generational amplification according to Darwinian evolutionary principles. Applying Diffie-Hellman, or RSA, ECC etc. is clearly the province of highly sophisticated Alice and Bob, but some limited version of the Birthday principle is conceivably a possibility for very simple Alice and Bob. The privacy may be limited, lifespan short, and the selection space S is small. We may consider a swarm behavior, communicating between biological entities, micro-entities, etc. Two important aspects of BP are the notions of identity and continuity. In a maze of many interacting entities it is important (i) to ascertain the identity of a communication partner, and to (ii) insure the continuity of communication with that partner. A chain of more and more shared secrets satisfies both. It insures that someone does not burst in and claims to be the communication partner from yesterday, and it is equally important to use the shared knowledge of secrets to generate confidence about the identity of one's partner. Another important aspect of BP, especially in its “birthday implementation” is the randomized process, which extend robust protection against predictability. The affinity function may serve as a basis for several implementations, and also a basis for further research into the development of language, and acceleration of evolution. Cryptographic applications are addressed separately. Off-Line Implementations: At this point we discuss:

### Parametric Socializing

Alice and Bob, two strangers, may test their

This procedure may facilitate and promote friendship and associations in the Internet crowd. Minster may be a dedicated agency, or it may be a social center, like Facebook. Minster can send Alice and Bob these lists to choose from, or he may publish them, and invite surfers to fill in as many lists as they like—lists on music, books, sports event, celebrities, etc. Minster will detect that two strangers, say Alice and Bob show great compatibility in a large number of lists, and then he will advice both that a match was found, asking them if they consent for a mutual exposition that may lead to new found friendship. It may be on a romantic basis, professional, or plain old friendship of interest. Alice and Bob could condition their consent for mutual exposition, saying—the other person must be age-compatible, geographically-compatible, gender-compatible, education-compatible etc. In fact Alice and Bob could insist that Minster would perform some background check on the person with which they are to be mutually introduced. Do they have a police record, for example? So Minster could be in a form of a dedicated agency for that purpose, promoting itself on account of only introducing worthy people to each other, and that customers don't need to worry about being introduced to objectionable characters. The idea could be taken by tangential companies, like BillGuard which houses shopping profiles of its customers. It could compile a shopping affinity and offer it to customers. And then add some specific questions to be answered by customers so as to find useful matches.

Minster could do the same with respect to groups. Namely, to identify among its customers, groups of people that have a mutual high affinity, and mutually expose them. Again, based on any conditions of geography, age, gender, etc. Much as the Internet facilitates so many romantic bonds, but this tool is more general and applies also for other human connections.

### Bilateral Privacy in the Public Domain

### Immunized Against Mathematical Cryptanalysis

Abstract:

Diffie-Hellman, RSA, El Gamal, and modern “pairings” solutions for bilateral privacy while using only public information exchange, all rely on mathematical complexity, which inherently is vulnerable to future mathematical short-cuts that would erode their essential security. Alternatively, one would rely on algebra of random variables where intractability is based on provable (and hence durable) probability considerations. We propose to secure Bilateral Privacy (BP) on such grounds: Alice and Bob randomly pick elements from the same public set, and mutually discover an element they have happened to both pick. This discovery entails a symmetric exchange of information regarding some well-randomized properties of the picked elements. Because both Alice and Bob know which elements they picked, they can deduce from the property exchange which is their shared picked element, while Eve—the eavesdropper—will need to examine the entire (large) public set, and at the end of her analysis she is likely to end up with unresolved equivocation as to the identity of the secret element now shared by Alice and Bob. Alice and Bob will then exploit their initial shared secret to execute another round of the same procedure, and then again based on the enhanced secrecy iterating as many times as desired, insuring privacy commensurate with the sensitivity of their information exchange. The “birthday” principle allows for a small number of picked elements from a fairly large set to be picked by both Alice and Bob and likely include a shared element. This article describes, and illustrates the generic solution; various implementation options, and practical considerations are offered in subsequent writings.

### Introduction

The prevailing tools for bilateral privacy while using public information exchange are based on mathematical complexity for which no cryptanalytic short-cut has been detected, but has not been ruled out. Modern cryptography eagerly awaits the coveted proof that P≠NP, to alleviate these concerns, yet even if such proof will surface, it will not remove the fears from “special cases” where hidden vulnerability will undermine the presumed integrity of a scheme. E.g. Pollard's p−1 method efficient against special RSA cases. Otherwise, there are unrated prospects for “accelerated brute force” searches, where searching through less than half the key space may be sufficient on average. What is more, civilian cryptographers are largely in the blind as to whether a mathematical intractability they rely on, has in fact been compromised. The growing number of national security cryptographic power houses that devote the ingenuity of thousands of professionals to crack the main stay mathematical intractabilities are equally dedicated to hiding their results in order to preserve their hard-won advantage. As civilian cryrptography emerges as a larger and larger foundation of our new cyber-culture such vulnerability is increasingly worrisome. The near future will likely witness the over-due blooming of digital cash. We surely can't deposit the financial wealth of humanity in a mathematical formula that is subject to a future Alice and Bob (the cryptographic equivalent for Bonnie and Clyde) who will rob all our money with a mathematical gun, that lay hidden until it showed up. Against these concerns one can present the process of random selection that by its essential nature is immunized against future mathematical insight—given the full credit and faith of science, and the philosophy of knowledge. If Alice randomly selects one shell out of 1000 shells to hide a pearl under it, then Bob is expected to pick-up, on average 500 shells before he would spot the pearl, and that it so regardless of how much smarter Bob may be compared to Alice. To allow Bob to search through less than 500 shells on average, is to discredit the randomization process used by Alice. If Alice resorts to the power of quantum mechanical measurements for her randomization then Bob will not be able to do better than 500 searched shells (on average). Bob can be faster, and turn-up shells in less and less time, or even turn them up virtually simultaneously—but this is not mathematical vulnerability, so in our context it does not count. Turning the pages of history one learns that the original breakthrough for the challenge of bilateral privacy vis public communication was provided by Ralph Merkle who came up with an ingenious idea: Alice offers a large number of difficult computational problems for Bob to choose from. Bob chooses, solves the problem he chose and communicates the solution back to Alice. Alice who beforehand solved all the problems she presented to Bob, will readily recognize which of the many problems Bob has randomly selected for his solution efforts. This solution then becomes the shared secret between Alice and Bob—even though they may be two strangers that just bumped into each other on the Internet. Eve—the eavesdropper—knows the full selection of problems to solve presented by Alice, but is clueless as to which one of them Bob has randomly selected. Bob surely knows, and Alice too—because she solved all these problems ahead of time. This gives Alice and Bob a temporary shared secret. Why temporary? Because given enough time Eve will solve all the problems presented by Alice, and find out which one Bob randomly picked. Because the shared secret is only temporary, and because Merkle's contemporaries Diffie and Hellman soon thereafter splashed their elegant method on the scene, providing for a durable shared secret—the Merkle solution did not catch fire. And the fact that unlike Diffie and Hellmans and their sort, like the RSA team, Merkle does not rely on one-way functions, was left unnoticed. We have come to revisit Merkle following the innovation guidelines offered by the Innovation Turing Machine [ref], and thus we abstracted his solution: Merkle solution is based on picking an element from an exposed set. By employing a random selection process Merkle has no vulnerability for prior theft, nor any means to predicting his pick—that's essential to randomness. And this process keeps Eve in the dark as to Bob's selection. By communicating his selection to Alice based on her pre computing all the answers, Bob achieves the shared secret status with Alice. The life span of that secret depends only on the computational powers of Eve. Eve has no hope to discover some yet unknown mathematical shortcut because by its essence a random selection process is unpredictable. We further realized that Merkle's scheme overloads Alice before the exchange, and keeps her idle while Bob is toiling with solving the problem he picked. One would opt for a more symmetric solution. Now, following the guidance of the Innovation Turing Machine, we zeroed in on this abstraction of Merkle's solution, and asked ourselves: suppose we construct a large set of some elements, and keep that set in the open. Now following the above analysis of the abstraction of Merkle's idea we may opt for a symmetrical random pick of an element from that set. If we could find a way to insure that both Alice and Bob will pick the very same element—then this element will constitute their shared secret against Eve. However, by allowing Alice to use a random process of her own, and Bob to use a randomization of his choosing, then how will we insure that they both pick the very same element from the large exposed set? The answer involved an innovative step forward: By allowing Alice and Bob to each pick not one but several elements from the same set, then chances are that there exists one element they both picked. We recall the famous “birthday” principle where the results are counter intuitive, and the same should apply here. So if both Alice and Bob do pick n elements randomly each out of an s-elements set, S, and each makes sure they picked n different elements, then the chance that their sets share at least one element is:

$${P}_{match} = 1 - \frac{( s - n ) ! ( s - n - 1 ) !}{s ! ( s - 2 n ) !} \qquad [ 1 ]$$

This formula can be deduced as follows: The chance for Bob's first pick to be different from Alice's n picks is (s−n)/s. Bob's second pick will be selected from (s−1) elements, and it's chance not to coincide with any of Alice's picks is (s−n−1)/(s−1). For Bob's third pick the chance not to coincide with Alice's pick is: (s−n−2)/(s−2) and so on. One then multiplies all these chances for Bob's n picks, and then subtracts this total chance from one, leading to equation [1] For s=25,000 and n=250 the chance for a match is P_{match}=92% Additional cases are depicted in table-1:

TABLE 1
Match probabilities
Match Probabilities for various combinations of
selectable count, s, and selected count, n

| s | n | probability |
|---|---|---|
| 100 | 5 | 27% |
| 1000 | 25 | 49% |
| 1,000,000 | 1000 | 63% |

It seems safe to say that this result is counterintuitive much as the birthday problem is. This remarkable chance to have a match out of two random selections of a small subset of the selectable items, is the underlying attraction for this Bilateral Privacy method. We can set up the values of s and n to practically insure that the two randomly picked sets will have at least one element in common. But now the question is how will Alice and Bob find out that shared element without disclosing the same to Eve, the eavesdropper? This required another innovative step: Let us endow the elements in the set with some q properties p₁, p₂, . . . p_{q}, and let each property accept v values. Let Alice pick a property i and compute the n values of that property for all its n pickings:

{Aᵢ}ₙ=(aᵢ₁,aᵢ₂, . . . aᵢₙ)

Alice will then communicate these n values to Bob, along with the identity of the property (i) she selected. Bob, on his part, will compute the values of same property i for all his pickings

{Bᵢ}ₙ=(bᵢ₁,bᵢ₂, . . . bᵢₙ)

Now, any element in his n pickings that its property i value is not found in the set of n values Alice sent, is clearly not the shared pick, so it can be written off

{b_{non-match}:{(bᵢₖε{Bᵢ}ₙ)U{Aᵢ}ₙ=Ø}

Alice then will select another property j and do the same—communicate to Bob the n values of the j property of her n pickings

{Aⱼ}ₙ=(aⱼ₁,aⱼ₂, . . . aⱼₙ)

Bob, will compute the j values of his pickings and write off any element that its computed j-value is not in the set that Alice sent over.

{b_{non-match}:{(bⱼₖε{Bⱼ}ₙ₎)U{Aⱼ}ₙ=Ø}

Alice then repeats this with a third property, a fourth, etc. After exercising this exchange over 1, 2, . . . i, . . . j . . . qₐ properties, Bob will identify match-candidates that would satisfy:

B_{match-candidate}={bₖ:∀(iεqₐ)(bᵢₖ∪{Aᵢ}ₙ≠Ø)}

Now suppose that Alice and Bob have no set element in common. In that case Bob will soon write off all his pickings, and so conclude. In that case Alice and Bob will replay: they will each pick a new set of n elements from the same s elements space. If they have one element in common, Bob will identify it because sooner or later Bob will write off all the other (n−1) pickings Everything that we described about Alice and Bob can be readily reversed, for Alice now to take the role of Bob, and find the shared element, like Bob does. Bob, on his part, will take Alice's role in the above procedure, select different properties, and communicate to Alice the respective property values of his pickings Alice, on her part, will compute the property values of her pickings with respect to the properties Bob has selected. She will then be able to write off any of her picked elements for which her computed property value was not found in the list Bob has sent her. She will continue to write off her pickings as Bob selects more and more properties and sends her the property values of his pickings. If Bob selects property ƒεq then Alice will conclude:

{a_{non-match}:(a_{fk}ε{A_{f}}ₙ₎)U{B_{f}}ₙ=Ø}

And after receiving from Bob the property values of 1, 2 . . . l . . . q_{b}, properties she will be able to designate her match candidates:

A_{match-candidate}={aₖ:∀(lεq_{b})(aₗₖ∪{Bₗ}ₙ≠Ø)}

The crux of the Bilateral Privacy method is that, as Alice and Bob symmetrically send each other property values of their pickings, the probability that they both identified the proper match between their picking (should it exist) is approaching certainty, or, if there exists no match, they both will so conclude with great certainty:

Pr{A_{match-candidate}=B_{match-candidate}=AB_{match}}→1 for qₐ,q_{b}→q [2]

This “meeting of minds” between Alice and Bob has been achieved via an information exchange that relies on what each of them uniquely knows their own pickings Alice knows {A}ₙ, and Bob knows {B}ₙ. A third party unaware of either of these sets will be at a disadvantage. The match becomes the shared secret of Alice and Bob, the basis of their bilateral privacy. In the rare case where Alice and Bob randomly picked more than one match, this methodology will flash it out; both Alice and Bob will reduce their picking to the same list of match candidates. In that case they would device some way to select a single one (perhaps by the largest id value of the element), or agree to combine the matches into a larger secret. For this method to be useful it is necessary for Alice and Bob to distinguish themselves from Eve the eavesdropper. Can Eve find the match? For starters, let's consider the simple case. Alice picks a property i computes the i-values for her picking, {Aᵢ}ₙ, and sends the definition of i, and {Aᵢ}ₙ to Bob. Bob realizes that (n−1) elements in his pickings are off since their i-values, as he computes them, are not present in the list Alice sent him.

b_{match-candidate}{bₘ:bᵢₘU{Aᵢ}ₙ≠Ø&b_{m′}U{Aᵢ}ₙ=Ø for ∀m′≠m [3]

He concludes that the survivor element bₘ is their shared one. Alice, symmetrically concludes the same with respect to some property j for which Bob computes his n values and sends her. So she too zeroed in on the same shared element—the shared instant secret. Eve, on her side, will know that the shared secret has an i value from the n values Alice sent to Bob, and a j-value from the n values Bob sent to Alice. So Eve knows that the match that Alice and Bob embrace as their private secret, S_{match}, satisfies:

S_{match-candidate}={∀t{sᵢₜε{Aᵢ}ₙ&sⱼₜε{Bⱼ}ₙ}} [4]

Where sᵢₜ and sⱼₜ are the i and j property values respectively of element sₜεS. Since Alice and Bob have complete control over the choice of S, n, and the q-properties, they may provide probabilistic assurance of equivocation, namely:

Pr[t≧e]=F(s,n,qₐ,q_{b}) [5]

Where e is Eve's equivocation level: e=1, 2, 3 . . . t is the number of sₜ elements that qualify as match-candidate in equation[4], and Pr reflects probability. Given a desired equivocation level, e, Alice and Bob can select the values of s, n, and qₐ, q_{b} such that Pr[t≧e]→1.0 In other words, Alice and Bob can design their Bilateral Privacy system such that Eve will be dead-ended with residual equivocation that she would not be able to eliminate, or reduce. We can say that Alice and Bob build their shared privacy on solid, provable probabilistic foundation which is in sharp contrast to the prevailing methods that rely on unproven assumptions for one-way functions. Given the fact that most one-way functions come with erosive intractability one might favor the durable attribute of this Bilateral Privacy. There is a certain measure of design, fine tuning, and parameter determination that needs to be done before this bilateral privacy in a public domain method is ready to work. Its critical distinction is clear from the introduction herein. In this method, Alice and Bob, two strangers on the Internet, quickly and reliably establish a durable secret between them by symmetrically constructing a common secret on the basis of instantly random information known to them and to no one else.

In the sections ahead we (i) offer a formal definition of this bilateral privacy method, (ii) introduce a mathematical construct called “the embryonic geometry” then (iii) show how to use this geometry to implement this bilateral method, and (iv) elaborate on implementation, and enhancement issues.

### Concept & Method (Basic)

The Challenge:

Alice and Bob have met in the public domain (online), and wish to exchange information in confidence so that the public in general, and Eve, the eavesdropper, in particular, will not be privy to the contents of their exchange. All their information exchange is exposed to Eve. We assume that they cannot use steganography, and the only way open for them is to encrypt their messages to each other. To carry out encryption they need to establish a shared secret key that Eve will not be in the know for it. Because they met in the public domain, they have not had the opportunity to use any secret channel to exchange a shared secret. So their challenge can be described as how to exchange information in the open for the purpose of establishing a shared durable secret key.

The Mathematical Environment:

Let S be a set called the ‘Source’ or the ‘Space’ comprised of s elements. Each element is associated with a unique information identifier. Alice and Bob desire to agree on one element in the Space, and use this shared secret agreement as the basis for deriving a secret cryptographic key. The challenge is then reduced to how would Alice and Bob manage to agree on an element in S, while denying that knowledge from Eve, who is exposed to all their communication. We assume that the space is in the open too. We shall address later the question of how to leverage the secret element in S for establishing a required secret cryptographic key.

Symmetry:

Alice and Bob act in complete symmetry, each, in turn does what the other does.

Step 1: Picking Candidates:

Alice and Bob, each picks n candidates from S, using some instant randomization method. Both Alice and Bob keep their pickings in secret. We refer to these pickings as Alice's picking and Bob's picking.

Step 2: Discovering Picking Matches:

Alice and Bob exchange certain information that helps them spot one or more candidates which both happened to pick in their randomized selection process. We refer to such a candidate as a ‘match’. If Alice and Bob mutually discover that they have no match, they repeat Step 1. If they discover more than one match, then they exercise a selection process or a combination process (e.g. the match with the candidate identifier that is of the lowest value). So at the end of this step Alice and Bob, either re-try with Step 1, or end up with a secret element in S such that Eve does not know which one it is, or does know it long after this knowledge is harmless for Alice and Bob.

Step 3: Leveraging the Discovered Match into a Durable Shared Secret:

Alice and Bob exploit the information that is exclusively theirs, and build from it a durable shared cryptographic key, which they subsequently use with any optional cipher to exchange any amount of information in reliable confidential mode. Steps 2 and 3 need elaboration. Step 2: the concept: We assume that the s elements in S are each associated with q computational properties: p₁, p₂, . . . p_{q}. Each of these properties may assume v numerical values¹. ¹ In practice each property may be defined with a different number of possible values, the uniform value, v, is used here for simplicity of calculating probabilities for cryptanalysis.

Step 2.1A:

Alice, having randomly picked elements {A}ₙ=a₁, a₂, . . . aₙ from S, now randomly picks a property pᵢ, and computes the i-values for her pickings:

{Aᵢ}ₙ=aᵢ₁,aᵢ₂, . . . aᵢₙ.

Step 2.2A:

Alice communicates to Bob (Eve intercepts) the identity of property pᵢ, and {Aᵢ}ₙ—the n i-values of her pickings.

Step 2.3B:

Bob computes the i-values of his picking:

{Bᵢ}ₙ=bᵢ₁,bᵢ₂, . . . bᵢₙ

Step 2.4B: Bob marks off any of his picking for which bₖ does not appear in

{Aᵢ}ₙ:b_{non-match}=bₖ:∀k{(bᵢₖε{Bᵢ}ₙ₎)U{Aᵢ}ₙ=Ø} [6]

This way Bob ends up with n_{b}ⁱ≦n elements that all have a probability to be a match with Alice.

If n_{b}ⁱ=0 then Bob notifies Alice that they have no match in their respective pickings, and so they would try again. (This would stop any symmetric analysis by Alice). If n_{b}ⁱ=1 then the single element that was not marked off in Step 2.4B is the ‘presumed match’. If n_{b}ⁱ>1 then Bob notifies Alice that she should repeat steps 2.1A and 2.2A, with another randomly selected property, and then Bob will follow with steps 2.3B and 2.4B, until n_{b}^{i . . . w}=1, or n_{b}^{i . . . w}=0, as the case may be. The index i . . . w represents all the properties that Alice randomly picked in her repeat action of steps 2.1A and 2.1B.

Symmetry:

Steps 2.1 to Step 2.4 are also, in parallel, performed in symmetry where Alice takes Bob's role, and vice versa, resulting in steps 2.1B, 2.2B, 2.3A, and 2.4A. At the end of these steps Alice and Bob each holds on to a ‘presumed match’ but they are not sure that they hold on to the same element in S. There is a chance that two different elements had sufficient commonality in property values that they passed the above tests. This possibility can be readily checked:

Step 2.5AB:

Alice and Bob agree on a symmetric ‘test cipher’ of choice (TC), and agree on a mathematical operation that would process the unique identifier of each of the two presumed matches into a bona-fide key for the test cipher, K_{TC}. Alice will then pick a random message Mₐ, encrypt it with TC using as key K_{TC}.^{a}—the key computed from her presumed match, and then send the respective ciphertext, C, to Bob. Bob will compute his version of the key based on his presumed match: K_{TC}.^{b}, and decrypt C to M_{b}, and send it to Alice. If Alice finds that Mₐ=M_{b} then Alice will notify Bob that they have a shared secret and the presumed match will become a proven match. If Mₐ≠M_{b} then Alice and Bob will go back to ‘square one’ and restart from steps 2.1A and 2.1B. Alternatively, Alice and Bob will agree on a random number R, and Alice will compute the crypto-square values of her candidate list: (Aᵢ+R)²|_{c} for i=1, 2, . . . m, and send these values to Bob. Bob will compute the respective square numbers of his list of match candidates, and notify Alice which of her squares numbers matches his. This will tell Alice the identity of the match. Eve, on her part will have to check on average 0.5 s elements to find that secret. At the successful end of this step Alice and Bob share a secret element in S.

Cryptanalysis:

The question of interest at this point is: “What does Eve know?” She knows the space, S, and she knows the values of the selected properties of Alice and Bob's pickings She knows that they found a match. But she does not know neither the n pickings of Alice, nor the n pickings of Bob. She will deduce that for each of the selected properties (by both Alice and Bob) the match has one of the communicated property value. So for every property i used by either Alice or Bob she knows that the match has one of the n values communicated between Alice and Bob². If all in all q=qₐ+q_{b} properties were used by both Alice and Bob then Eve will look for an element sₑεS such that for every property iεq its i-value, sᵢₑ, will be one of the communicated values:

{sₑ:sₑεS&∀(iεq)sᵢₑ∪{γᵢ}ₙ≠Ø} [7]

Where {γᵢ}ₙ represents either {Aᵢ}ₙ or {Bᵢ}ₙ as the case may be. Since Eve has no knowledge of neither {A}ₙ, nor {B}ₙ, and she knows that both of these two sets were selected randomly, she has no better search strategy (for sₑ satisfying equation #7) than any random brute force approach. So, on average, she will be bound to compute

$${Eve}_{compute} = \frac{s}{2} ( {q}_{a} + {q}_{b} ) = \frac{sq}{2}$$

property values, while Alice, and Bob compute just Alice_{compute}=Bob_{compute}=n(qₐ+q_{b})=nq. So Eve's computing load is

$$\frac{s}{2 n}$$

times more than Alice's and Bob's. Since Alice and Bob freely select the values of s and n, they freely determine the extra work load facing their eavesdropper. ² The number of values may occasionally be smaller than n for any property; it may so happen that two picked elements will share the same value for any given property.

Eve's extra work-load will provide Alice and Bob some useful lead time. If they have good information regarding Eve's computing power then by setting proper values for s, and n, Alice and Bob will determine how much time of privacy they have before Eve catches up with their knowledge. If, for example, Alice and Bob need their privacy to execute a digital payment then a short lead time will be sufficient. If they need their privacy to exchange secret of strategic importance then they will need to safeguard their privacy for a long time, and that is where this Bilateral Privacy method offers its important feature of residual equivocation: forcing Eve to a state of unresolved uncertainty over the shared secrecy that Alice and Bob have established with nearly full certainty. Eve's residual uncertainty is not subject to erosion due to any extraordinary computing power, nor is that uncertainty at risk from some yet unpublished mathematical insight. Eve's unshakable equivocation with respect to Alice and Bob established secret is based on random arithmetic, not on the assumed intractability of a computational challenge.

Residual Equivocation:

In order to simplify the equations let's assume that all the q properties assigned to elements of the space S are each expressed via v values, and let's further assume that all these values are uniformly distributed. When Alice and Bob conclude this Bilateral Privacy procedure they have exposed to Eve (q=qₐ+q_{b}) properties, and the knowledge that the shared secret element in S has one of the up to n values for each property. We can now calculate the chance for a random element in S to qualify as the shared secret—the “match”—that Alice and Bob agreed upon. For a given property that can assume v values, the chance that a random element in S does not have a given value communicated between Alice and Bob is

$$\frac{v - 1}{v} .$$

The chance that such element, for that property will not assume any of the n values of that property reported by Alice or Bob is:

$$( \frac{v - 1}{v} ) n$$

The chance that the value of some property iεq for element sεS will be one of the n values reported by Alice or Bob is:

$${P}_{si} = 1 - ( \frac{v - 1}{v} ) n$$

But for element s to be a match-candidate, as far as Eve is concerned, it is necessary that for each of the reported (q=qₐ+q_{b}) properties the value of that property for that s element will have to be one of the n values reported for each property. Hence, for a random element sεS the chance that it would be a match-candidate (the newly established shared secret of Alice and Bob) is:

$${P}_{s \text{-} match} = {( {P}_{si} )}^{q} = {( 1 - {( \frac{v - 1}{v} )}^{n} )}^{q} \qquad [ 8 ]$$

And accordingly, the expected residual unresolved equivocation faced by Eve is:

$$e = {Eve}_{equivocation} = F ( s , n , q , v ) = {s ( 1 - {( \frac{v - 1}{v} )}^{n} )}^{q} \qquad [ 9 ]$$

Where s in this context is the number of elements in S (s=|S|), and e is the expected number of elements in S that as far as Eve is concerned could each qualify as the secret match established by Alice and Bob. Eve has no additional information with which to resolve that residual equivocation, and no amount of computing power will do her any good.

Since Alice and Bob control the values of s, n, v, and q they have the power to determine the residual equivocation faced by Eve. For some typical values please consult the table below:

Equivocation Values (e) for the Bilateral Privacy Procedure
Determined by space size (s), Alice and Bob picking size (n), possible
values for properties, (v), and number of used properties (q)

| s | n | v | q | e |
|---|---|---|---|---|
| 10000 | 300 | 500 | 6 | 83 |
| 10000 | 300 | 100 | 6 | 7351 |
| 1,000,000 | 1000 | 1000 | 8 | 24816 |
| 1,000,000 | 1000 | 500 | 10 | 221302 |
| 1000 | 50 | 250 | 6 | 0 |

The last case represents a situation where Eve would end up with no equivocation, and will find for certain the secret match between Alice and Bob. All other cases represent various levels of residual uncertainty. It's important to note that Eve's residual uncertainty will be durable only if Alice and Bob skip the secret verification step (Step 2.5AB), and agree to risk a small chance of a bilateral mistake. The verification step, wipes off Alice and Bob apprehension for a bilateral mistake, but it also wipes off Eve's residual equivocation. If verification is used then Eve can eventually be at par with Alice and Bob knowledge wise, after having spent sufficient time to check all the members of S.

Considerations:

Alice and Bob have a natural interest to increase the equivocation facing Eve, but in determining the values of s, n, v, and q, they would bring into consideration additional factors:
The chance for a mistaken match
The chance for having no match

As discussed, Alice and Bob can readily handle both situations: a mistaken match may be flushed out by the cipher-test, and in the case where no match is found, Alice and Bob will try again. However, both outcomes impose additional burden on Alice and Bob, which may lead them to strive for optimization of the procedure's parameters. The larger the size of their pickings (n), the greater the chance for a match, but also the greater the chance for mistaken matches. The smaller the variety of properties values (v), the greater Eve's equivocation, but also the mistake chance is greater. The more properties identified in the exchange (q) the smaller the equivocation, and the smaller the mistakes. The guiding equations are:

$${P}_{mistake} = 2 {nP}_{si}^{q} = 2 {n ( 1 - {( \frac{v - 1}{v} )}^{n} )}^{q} \qquad [ 10 ]$$

And equation [1]. Some situations are depicted below:

Balance Among Equivocation, Mistakes, and Repetitions
for the BP Method

| | | | | | | | Match |
|---|---|---|---|---|---|---|---|
| | | | | equiv- | mis- | Match | in 5 |
| s | n | v | q | ocation | takes | % | tries. |
| 1,000,000 | 500 | 1000 | 6 | 3519 | 4 | 22% | 71% |
| 1,000,000 | 500 | 750 | 6 | 13,841 | 14 | 22% | 71% |
| 1,000.000 | 500 | 1500 | 6 | 482 | 0 | 22% | 71% |
| 1000 | 50 | 150 | 4 | 6 | 1 | 93% | 100% |
| 10000 | 150 | 500 | 4 | 46 | 1 | 89% | 100% |

“Match %” represents the chance that the pickings of Alice and Bob will result in a match on a single try, while “Match in 5 tries” reflects the chance for finding a match in five tries.

A casual observation of the above table indicates that Alice and Bob can easily find effective parametric values for exercising this Bilateral Privacy method, insuring residual equivocation for Eve, while securing a fast and easy exchange for them to establish their mutual privacy in the public domain.

### Leveraging the Initial Instant Secrecy

Alice and Bob, upon conclusion of Step 2, have now a shared secret: the identity of a single element in the space set S of s elements. Eve, their eavesdropper, needs a lag time Tₑ in which to evaluate the entire space in order to spot e match-candidates, such that one of them is the secret element shared by Alice and Bob. If e is sufficiently small Eve will be able to try all her e candidates until she spots the cryptographic key that Alice and Bob are using for their subsequent communication. For that reason, Alice and Bob may opt to increase their measure of security. They can do so by leveraging the secrecy they already have, let's denote it as Wₒ. Wₒ will nominally be the data identifier for the match. They will now use Wₒ in order to repeat a similar Bilateral Privacy scheme. While in the original scheme, Eve was aware of S, and the selected properties, in the second Bilateral Policy scheme, which is based on Wₒ, she will know much less, and hence her equivocation by the time Alice and Bob concluded the second scheme, will be considerably higher. The privacy, or say, secrecy gained after the second round will be referred to as W₁, and the time it will take Eve to discover W₁ will be much greater than the time needed for her to discover Wₒ. Alice and Bob can now repeat the same for another round, and generate a more secure secret W₂, and so on t time to generate W₍ₜ₋₁₎. There is no limit to how many rounds Alice and Bob can carry out, and since each round adds security based on tight probability computation, there is no fear of a penetrating mathematical short-cut that would fish out Wₜ. This will lead to implementation strategy in which Alice and Bob invest in their shared secrecy to the extent warranted by the sensitivity of the information they plan to exchange. Once Alice and Bob hold secret Wₜ which they deem sufficiently secure, they may use it with any cipher of choice, and of course be vulnerable to any breach of their choice cipher. Albeit, one has to distinguish between this working-cipher vulnerability to the vulnerability of the instant shared secret used to generate its key.

One could submit that whatever the equivocation e for Eve, she will eventually be able to negotiate it with brute force, trying all the matching candidates, and using all subsequent communication between Alice and Bob as raw inferential material. But if the secret is being used to generate the greater secrecy in the next round, then after that round Eve's equivocation rises to e², and to e^{t} after t applications. This gives Alice and Bob the tools to decide how much security to build around their intended communication. If we suppose that Eve sees just 10 candidates for a match, and it takes her no more than a second to establish the validity of a candidate, then if on average the equivocation level is e=10, and it takes her no more that 1 second to check a candidate then if Alice and Bob will practice 10 similar rounds they will achieve a whooping equivocation of 10¹⁰ sec=317 years. It is important to stress again, that this method allows for hard core probability computation to specify the computational load facing Eve in her attempts to cryptanalyze Alice and Bob secrecy.

Leveraging Technique:

The question is now: what will be a good procedure to leverage Wᵢ to become Wᵢ₊₁ (the next round secrecy). Some options:
Stream cipher seed
secret properties

It is simple and straight forward to use the Wᵢ secrecy as a seed to be fed into a stream cipher to generate a long pseudo-random series from which to build a new space, S′, and new properties p′₁, p′₂, . . . p′_{q′}. And then use this new construction in the way the first round of secrecy was achieved. In this mode Eve will be exposed to the communication between Alice and Bob where they will agree on the stream cipher structure, on how to carve its resultant pseudo-random stream to build a new space and new properties. Eve though, will be ignorant of the seed (which is the shared secret from the previous round), and hence of the identity of the bits in the pseudo-random string that is generated from that seed. A simpler way is to modify the property computation to include the latest secret. In that case Eve will know the space (it did not change), but will be unable to copy compute the values of the properties because the formula for that calculation includes the latest secrecy which Eve does not possess.

### Equivocation Computation

Alice and Bob select a space of size s elements, and randomly each pick n elements therein. Clearly the larger the value of n, the more rounds of property checks they will have to go through before they exclude all but one of their choice elements. On the other hand the smaller the value of n, the greater the chance for not having a match between them. The larger the value of s, the greater the expected equivocation for Eve, but then the greater the value of n will have to be to make it likely enough to harvest a match. Alice and Bob optimize among these conflicting drives and settle on values for s, and n based on equations [8], [9], and [10]. The lower the probability for success, the more times they will have to try to reach a match. The chance for any element in S to have a particular value for a given property is 1/v. This is under the assumption that Alice and Bob selected the properties so that each of their v values will be equally popular. So the chance for each element to have one of the n values for the given property, as communicated between Alice and Bob is n/v. This is because having one value per property is exclusive of having any other values. The above is valid up to a value of 1, and remains 1 for higher values. The chance for a given element of S to have both a value for a given property among the listed n, and the same with respect to a second property is (n/v)². And so the number of elements that Eve will find in S that qualify as a match (based on her knowledge) is, on average: e₂=s(n/v)². Where e₂ is Eve's equivocation over two properties. So, for s=1,000,000 n=1000 and v=10,000 Eve will have an equivocation value of 10,000. Namely 10,000 elements in S will be considered by Eve as match candidates. Eve will have to check all the 1,000,000 elements to extract those 10,000. The time required for her to identify the 10,000 is the temporary computational advantage of Alice and Bob, and the residual 10,000 is the durable advantage (which erodes as Alice and Bob use their secret in subsequent communication). For these values of n and s, the chance for Alice and Bob to net a match is 65%. If Alice and Bob find it necessary to exercise r rounds to extract the match then Eve is exposed to 2r lists for 2r properties, and in that case her equivocation is more limited:

eᵣ=s(n/v)^{2r} [11]

So for the above case, for three rounds (r=3) Eve's equivocation will shrink to 100. It is important to note that these values are expected probabilities, but the randomized process insures for these numbers to be reliable. What is more, Alice and Bob know full well what is Eve's equivocation. They design their case accordingly.

### Algorithms and Procedures

There are numerous ways to construct specific algorithms to implement the concept outlined herein. We focus on:
Modular Arithmetic
Embryonic Geometry

for property computation, and for both, we also address the question of constructing the S space. The S space is a set of s elements, each associated with a unique identifier. One simple way to construct S is to agree on a base number b (some large natural number), and designate the numbers: b+1, b+2, . . . b+s as the S space. Alternatively one could select a high limit H, and apply a randomization process to pick s numbers in the range 1, 2, 3, . . . H. In general any formula ƒ in the form ƒ(s) may point to an identifier for the s elements.

Modular Arithmetic:

The property of an element with an identifier x may be computed as:

xₚ=p^{x} mod v [12]

Where p is a random value that identifies the property, and v is the number of possible values for that property. So for properties P₁, P₂, . . . Pₖ element x (with identifier x) will have the following x₁, x₂, . . . xₖ values:

xᵢ=pᵢ^{x} mod v [13]

Note:

The value of v may be different for every property, if so desired. The uniform v is described here for simplicity of probability calculations.

In the next time around, the elements identifiers {x}ₛ, and the properties identifiers {p}ₖ will be compiled using the shared secret from the earlier round. The embryonic geometry algorithm will be described ahead, following the presentation o

### Embryonic Geometry

The embryonic geometry is a construct where a set of elements (points) is configured so that between every pair of points there exists a mutual property called distance which is a rational number. It's called embryonic because in its basic definition the values of the 0.5s(s−1) distances between the s elements are unrestricted. This allows this set to subscribe to certain impositions, e.g.: the metric space restriction, and approach any given, “mature” geometry, like Euclidean, projective, non-Euclidean etc. We recruit this construct to our aim here. We consider a space S comprised of s elements identified by unique data identifier, which may be a simple natural number count: 1, 2, . . . , s. We define s² distances between them, such that only the distance between an element and itself is zero, and all distances are limited to {Z_{N}}=0, 1, 2, . . . N−1 where N is an arbitrary large number. We define a line segment, or for short, a line, on that space as any sequence of elements in S. The first element is the beginning of the line, and the last element is the end of the line. The length of the segment is the sum of the distances between the ordered sets:

L₁₋ₜ=Σ₁^{t-1}d(i,i+1) [14]

where L₁₋ₜ is the length of the line from point 1 to point t, and d(i,i+1) is the distance from element i on the line to element i+1. A point (element) in S can be projected on any line. The projection is the element on the line such that the distance between it and the projecting point is the smallest. If several points on the line all share the smallest distance then the first point in the line sequence is the projection point. The value of the projection is the length of the line from its beginning to the projected element. Clearly every point in S has a projection measure with respect to any line in S. That projection may be regarded as a property of the projecting point with respect to the line segment on which the point is projected. By selecting the size of the segment one selects the respective equivocation because the distances between the points are randomly distributed. So a line segment defined over u points will be one where each of the u distances that may be the measure of a property of a point will have the same chance of being that result, so for each distance the chance is 1/u. Unlike the modular arithmetic base for properties, the embryonic geometric base is very easy to compute, the burden thereof is very uniform and predictable, and instead of complicated iterative computation one is facing an extensive database retrieval proportional with the size of the space S. The embryonic geometry solution also lends itself to a very easy and powerful second round. Suppose Alice and Bob concluded a first BP round, and agreed on a shared secret, W. (note that W is an element in the selection set S). They could now modify the properties that they used in the first round to say that instead of projecting the picked point, x, onto the selected line, one would project a derived point x′, where x′ is a function of x and the shared secret in the former round, W: x′=ƒ′(x,W). Since Eve would not know W, she would not know x′. As an example for this function f′ one could use: let x′ be such that its distance from W is the closest to the distance from x to W:

x′:{x′εS&x′≠x&|d(x′,W)−d(x,W)|ₘᵢₙ}

This definition forces one to search through S to map x to x′.

### Embryonic Geometry Illustration

Let us consider a small space containing 10 elements (points) marked: 1, 2, 3, 4, 5, 6, 7, 8, 9, 10. We apply a randomization process to determine the 90 mutual distances between these points. We arbitrarily choose the randomization range to be: 1-1000. These distances are written in the table below:

| | pnts | | | | | | | | | |
|---|---|---|---|---|---|---|---|---|---|---|
| pnts | 1 | 2 | 3 | 4 | 5 | 6 | 7 | 8 | 9 | 10 |
| 1 | 0 | 772 | 856 | 976 | 476 | 843 | 676 | 136 | 483 | 834 |
| 2 | 772 | 0 | 767 | 888 | 995 | 964 | 974 | 200 | 606 | 951 |
| 3 | 856 | 767 | 0 | 639 | 542 | 411 | 15 | 607 | 881 | 4 |
| 4 | 976 | 888 | 639 | 0 | 873 | 222 | 688 | 477 | 745 | 327 |
| 5 | 476 | 995 | 542 | 873 | 0 | 930 | 424 | 349 | 266 | 76 |
| 6 | 843 | 964 | 411 | 222 | 930 | 0 | 940 | 905 | 882 | 96 |
| 7 | 676 | 974 | 15 | 688 | 424 | 940 | 0 | 618 | 130 | 520 |
| 8 | 136 | 200 | 607 | 477 | 349 | 905 | 618 | 0 | 457 | 552 |
| 9 | 483 | 606 | 881 | 745 | 266 | 882 | 130 | 457 | 0 | 244 |
| 10 | 834 | 951 | 4 | 327 | 76 | 96 | 520 | 552 | 244 | 0 |

We now mark five lines in this space, defined as a sequence of elements:

| | Line Elements from first to last (7 elements in each line) | | | | | | |
|---|---|---|---|---|---|---|---|
| Line L1 | 4 | 5 | 2 | 0 | 3 | 1 | 6 |
| Line L2 | 3 | 9 | 5 | 0 | 5 | 1 | 2 |
| Line L3 | 2 | 3 | 4 | 1 | 9 | 8 | 7 |
| Line L4 | 6 | 7 | 9 | 1 | 0 | 4 | 2 |
| Line L5 | 4 | 2 | 8 | 7 | 3 | 0 | 9 |

Both the space and the lines are communicated in the open between Alice and Bob.

Each of the 10 elements in the space has a projection on each of the five lines in that space. The projection, as defined, is expressed by the length of the line from its first point to the point which is the closest to the projecting point. For illustration purposes let's calculate the projection of all the 10 elements in the space on all the five lines defined over the same space:

| | pnts | | | | | | | | | |
|---|---|---|---|---|---|---|---|---|---|---|
| lines | 1 | 2 | 3 | 4 | 5 | 6 | 7 | 8 | 9 | 10 |
| 1 | 2197 | 4061 | 1341 | 3173 | 0 | 930 | 5035 | 2197 | 5035 | 1341 |
| 2 | 1266 | 3073 | 3840 | 0 | 327 | 423 | 3840 | 1266 | 327 | 327 |
| 3 | 4159 | 2507 | 0 | 639 | 1512 | 3458 | 0 | 4159 | 3702 | 3458 |
| 4 | 2893 | 2121 | 3911 | 1170 | 3369 | 1170 | 0 | 618 | 0 | 1170 |
| 5 | 3333 | 1880 | 542 | 2357 | 0 | 4167 | 542 | 1880 | 1423 | 4167 |

Alice and Bob decide to choose three points in the agreed upon space. This will give them a probability of 67% to have a match—an element they both picked. They may consider this probability high enough, since if they don't have a match the first time around, they can try again, until they get a match.

No Match:

Let's first see what happens in a “no match” situation. Alice picked elements: 1, 2, 3, and Bob picked, 8, 9, 10. Alice will then send Bob (all in the open) the projections of her picks over line 1: 2197, 4061, 1341 (see table above). Bob will also compute the three projections of his picks over the same line: 2197, 5035, 1341. Bob will readily realize that point 9 has not been picked by Alice because its projection is not on her list. However, points 8, 10 have a projection on line 1 that exists on Alice's list. So points 8 and 10 are a candidate for a match. Bob then signals to Alice to keep going. So Alice projects her three picks on line 2: 1266, 3073, 3840. She sends those projections to Bob. Bob compares Alice's list to the projections that he calculates from his remaining candidates, which in this case are elements #8, #10. The projection element 8 and 10 on line 2 computes to: 1266 and 327. So point #10 is out—its value is not on Alice's list, and point 8 remains a viable candidate. Bob might be inclined to conclude that point #8 is a match. However, as we will see below Alice analyzing her situation in parallel will conclude that there is no match, so notify Bob, so the two of them will pick another random pick each. However, suppose Alice had the same situation and she wrongly assumed that one of her picks, say #2 is the coveted match. In that case both Alice and Bob maintain an erroneous notion of having a match. As it turns out, this is not a big calamity since before starting normal communication based on their secret they will test it. Alice will take a random message Rₐ and encrypt it via some agreed upon cipher, using the identity associated with her pick as key. She will send the ciphertext to Bob, who will decrypt it using the same cipher with his own assumed match. Bob will send his decryption, R_{b} to Alice. Alice will compare the two messages, and find that Rₐ≠R_{b}. She will then conclude that their assumed match, is not a match after all. Tell Bob, the bad news, and both will immediately pick another random set each. Alternatively Alice will crypto-square element #2, and communicate the result to Bob. Bob, on his part will crypto square his match candidate, element #8. Based on the property of the crypto square, Bob will virtually certainly compute a different square result and then notify Alice that her match candidate is different from his match candidate. The same sequence as above happens in the reverse. Bob first projects his three picks on line 3 and he sends the result to Alice: 4159, 3702, 3458. It is crucial to note that Bob submission to Alice will be over a line not used by Alice. Because if they both send each other the projections of their picks on the same line then Eve will be on par value information-wise, and they will lose the knowledge-advantage that is the basis of the entire procedure. So in this illustration lines 1 and 2 are foreclosed for Bob, and hence he projects his points over line #3. Alice compares Bob's list to her own: 4159, 2507, 0 She immediately marks off points 2, and 3 as bad candidates, but keeps point 1 as a viable option because its projection on line 3 appears in Bob's list. She then notifies Bob that she has not marked off all her picks, and requests him to choose another line and send over his projections. Bob then projects his points (#8, #9, #10) on line 4: 618, 0, 1170. Alice projects her only remaining candidate (point #1) on line 4: 2893—which is not on Bob's list. So she too, like Bob, reaches the conclusion that there is no match.

Match!

Let's now see the dynamics if in the case that happens about ⅔ of the times: Alice picked set contains a match with Bob's pick. Let Alice Pick, as before: #1, #2, #3. And let Bob pick #3, #4, and #5. Like before Alice might project her picks on line 1, and send: 2197, 4061, 1341. Alice of course notifies Bob that she projected her points on line 1, so he does the same: 1341, 3173, 0. (Note that the value of zero does not indicate that Bob picked the first element of line 1. He could have picked another element in the space such that its distance from the first element on line 1 is shorter, or no longer, than its distance to all other elements on the line). Bob will immediately discard points 4 and 5 since their values are not in Alice's list. Point #3 remains a viable candidate because its value is in Alice's list. Bob then asks Alice to use another line. She complies, and projects her picks on line 2: 1266, 3073, 3840. Bob projects point #3 on same line: 3840. This figure is on Alice's list, so Bob concludes that Alice too picked element #3. He can cement his conviction by asking Alice to project her points on another line, and verify that the projection of point $3 on that line appears in her list. Or he could propose to Alice to verify his candidate, using, say the crypto-square tool. Alice, in parallel will ask Bob to pick another line, and send her the projections of his picks. He complies, and projects points #3, #4, #5 on line 3: 0, 639, 1512. Alice projects her picks on the same line: 4159, 2507, 0. She immediately marks of points #1 and #2, and keeps point #3 as a viable option. She signals to Bob to project his picks on another line. He chooses line 4: 3911, 1170, 3369. Alice projects her sole viable point (#3) on same line: 3911—it's on the list. So she too, in parallel to Bob, concludes that both have randomly picked the same point: #3. Eve: Let's focus now on Eve's perspective. She knows the following: (i) the identity of the space, (ii) the identity of the lines used by both Alice and Bob, and (iii) the projections of Alice points on line 1 and line 2, as well as (iv) the projections of Bob's points on line 3 and line 4. She also knows that Alice and Bob have a match, and that they both found it. She concludes that the match projects on line 1 as 2197, or 4061, or 1341—the values Alice sent to Bob as projections of her points on line 1. Therefore it is in the set of: #1, #2 , #3, #8, #10. She also knows that the match projects on line 3 as: 0, 639, 1512 so it must be in the set: #3, #4 , #5, #7. Eve will then rightly conclude that the match is #3, since this is the only element that belongs to the two sets. So what have we achieved here? Eve ends up learning the same knowledge that Alice and Bob have learnt. Where is the advantage? Well, in this particular case Eve ends up with no equivocation at all, but she does suffer delay. This is not so well illustrated in this small size illustration, but the case is that for Eve to conclude the above she has to project the entire space on each line (table #3 is not given, it must be computed). Alice and Bob reach the same conclusion by evaluating the projections of only their picks. The entire value of this scheme is based on the familiar “birthday effect”—the number of workable picks is much smaller than the number of elements in the space, and so Alice and Bob, when using the same over a large enough space, secure a temporary advantage over Eve—as is the case in the classic Merkle scheme. However, Alice and Bob have full control on all the parameters: the size of the space, the number of picks, the distribution of distance values, the size and identity of the lines—and hence they may set it up so that Eve is likely to end up with residual equivocation that she cannot resolve. If Bob would have picked line #4 first then the projections values that he would have sent to Alice would have been: 3911, 1170, 3369, and in that case Eve would conclude that the match is in the list: #3, #4 , #5, #6, #10. In that case Eve would have ended up equivocated because she would not know whether the match is element #3, or element #10 since both appear in the two lists. So in this case, Eve, is not only behind in the computation, she ends up with a residual equivocation while Alice and Bob established their match—their shared secret with a much reduced measure of equivocation. Of course, the more data snatched by Eve (the more lines data) the smaller the equivocation, but the longer the delay—the greater the computational burden add-on for Eve over Alice and Bob.

Illustration—Cascade:

Alice and Bob would have the option to bolster and fortify their just achieved shared secrecy (both agree on element #3, without Eve so realizing, at least for a while). They would do so by, replaying the procedure above but use the shared (temporary or not) secrecy to ‘massage’ the values of the various parameters for the procedure. Since Eve does not have a timely knowledge of the shared secret, she will not be able to repeat her cryptanalysis the way she did it in round one. Here are some ways to massage the parameters:
modular logarithm
re-lining
mirroring

In modular logarithms one simply modifies all the numeral values, by computing its modular power raising with the identity of the shared secret. Any distance value between any two points i≠j will be computed to value d(i,j)′:

d(i,j)′=1+d(i,j)^{W} mod N

where N is the upper limit of the randomization range for the distance in the space. W is the identity of the shared secret, secured in the former round (in this illustration, round 1). The “plus one” is to account for the fact that the distances between two non-identical elements must be greater than zero. This will keep the distribution of the distances from 1 to N, as before, but all the distances will be changed, and hence the interpretation of the projections of the various points on the various lines will be changed. Alice and Bob will both be aware of the changes, and readily compute them, but Eve, unaware of Alice and Bob shared secret, will not. That means that in the second round Alice and Bob will create a more durable shared secret, even if there would be no residual equivocation. In our illustration Alice and Bob, for the second round will modify all the non-zero distances in the space, S according to:

d(i,j)′=1+d(i,j)³ mod 1000

And applying this formula to the space S results in the following distances matrix:

TABLE #4

| | pnts | | | | | | | | | |
|---|---|---|---|---|---|---|---|---|---|---|
| pnts | 1 | 2 | 3 | 4 | 5 | 6 | 7 | 8 | 9 | 10 |
| 1 | 0 | 649 | 17 | 177 | 177 | 108 | 777 | 457 | 588 | 834 |
| 2 | 649 | 0 | 664 | 73 | 876 | 345 | 425 | 1 | 17 | 951 |
| 3 | 17 | 664 | 0 | 120 | 89 | 532 | 376 | 544 | 842 | 4 |
| 4 | 177 | 73 | 120 | 0 | 618 | 49 | 673 | 334 | 626 | 327 |
| 5 | 177 | 876 | 89 | 618 | 0 | 1 | 25 | 550 | 97 | 76 |
| 6 | 108 | 345 | 532 | 49 | 1 | 0 | 1 | 626 | 969 | 96 |
| 7 | 777 | 425 | 376 | 673 | 25 | 1 | 0 | 33 | 1 | 520 |
| 8 | 457 | 1 | 544 | 334 | 550 | 626 | 33 | 0 | 994 | 552 |
| 9 | 588 | 17 | 842 | 626 | 97 | 969 | 1 | 994 | 0 | 244 |
| 10 | 704 | 352 | 65 | 784 | 977 | 737 | 1 | 609 | 785 | 0 |

So now, if Alice would want to communicate to Bob that a certain point in her pickings projected on element #1 in line 1, she will not say:

projection=d(5,6)+d(6,3)+d(3,1)=930+411+856=2197

but she would rather say:

projection=d(5,6)′+d(6,3)′+d(3,1)′=1+532+17=550

Bob will follow Alice computation, but Eve will not (for a long time).

Re-Lining:

Alice and Bob could use the shared secret element of S to re-line the randomly picked lines on which to project their pickings There are many re-lining options. For example: to fit the secret element between every two successive elements in the line. So, if Alice will randomly select a line: l₁, l₂, . . . lₘ, and communicate it to Bob, then Bob will understand that the line onto which he has to compute the projection is the following:

l₁,s,l₂,s, . . . , s,lₘ

The distance of projection on that new line will be readily computed by Alice and Bob, who are privy to the identity of the shared secret, but not so to Eve.

Mirroring:

The shared secret element, s, in S may serve as a mirroring hinge for every other element in S. Element x in S will be flipped to its mirror x′ over s, where x′ is the element for which:

|d(x,s)−d(x′s)|ₘᵢₙ

If there are two candidates, x′ and x″ such that:

|d(x,s)−d(x′,s)|=|d(x,s)−d(x″,s)|

then the mirror for x will be x′ if d(x,x′)>d(x,x″), and it will be x″ if d(x,x′)<d(x,x″), and it will be s if d(x,x′)=d(x,x′). This procedure will flip every element in S to another element in S, as determined by the identity of the shared secret s. This mirror flipping will apply to the random picks of Alice and Bob, as well as to the lines over which these picks are projected. This mirror flipping complexity will apply to every round of finding another secret, however many rounds there are.

### Use & Application

The bilateral privacy method can be used in instances where two parties wish to converse confidentially. The use types can be categorized in several ways:
by the type and class of the privacy seeking parties
by the nature of the private communication
by the setting in which the private communication takes place.

The communicating parties may be mutual acquaintances or they may be strangers, they may be human beings of computing centers, they may need mutual non-repudiation, or they may need a receipt of the exchange. The communication itself may be rare, random, or frequent and anticipated. Its security needs may be minimal, moderate, or high. The communication may be over the Internet, over the phone, or otherwise. The embryonic space that underlies this methodology may be agreed upon by Alice and Bob who will each keep a copy in their computing environment, or alternatively they will agree to both use a third-party offered cloud-based space.

### The Type and Class of the Privacy Seeking Parties

We can distinguish between the following classes:
one time strangers
strangers becoming acquaintances
acquaintances

One time strangers will have to agree on the shared tool, the required security, and then on the nominal cipher that will use the generated secret. The shared secret, then will never be used again, and Alice and Bob can both erase all the data generated in the process. If Alice and Bob are strangers who plan a series of communication, then, if they generated a sufficiently secure shared secret they can use for some agreed time, without having to regenerate. If Alice and Bob are acquaintances then presumably they had a chance to exchange a secret key over a secure channel. If the secure shared secret is the actual cryptographic key they use in the bilateral communication then there is a chance that it was stolen from either one of them and their communication is compromised. They may opt to use the shared secure secret as data from which to build the parameters of the space and the attributes therein. In that case they could use very simple security to generate the BP shared secret, sufficient for a thief of the shared secure secret to be frustrated about the real communication key, which Alice and Bob will produce using the BP method. To stress this point: Instead of using a stored shared secret key, which could have been compromised from the time stored to the time used, Alice and Bob will use that key to generate a space S like here described, and apply this “birthday method” to extract a shared secret key that is generated right at the moment it is being used so there is no time to steal it earlier. A hacker who stole the stored key will still not be able to ascertain the identity of the key actually used by Alice and Bob because that key would be shielded by the security measure offered by this “birthday method”.

### The Nature of the Private Communication

The secured private communication may be short, and sporadic, or long and regular. It may be file transfer, or it may be challenge-response dialogue. One particular use is for electronic payment. Unlike the Diffie-Hellman and its sort, this Bilateral Privacy method is cascade-based, meaning its provided security increases with the computational effort invested in exercising the procedure. We can then consider the BP provided security function over time, BP(t), or over a computational effort c, BP′(c), as a rising monotonic function. Hence, given an encryption security requirement at level e, then a given implementation of the bilateral security will be associated with a computational effort, c, and a computational time t:

e=BP(t)=BP′(c)

And when a certain data exchange is judged to require an encryption security, e, Alice and Bob will be able to assess how much lead time, t, will be required for the necessary security to be established using the BP methodology. If Alice and Bob converse in a challenge-response dialogue, then there usually are ‘dead times’ between the occasions of data exchange. This dead time can be used to continue and cascade up the BP privacy. This may lead to a strategy of Alice and Bob beginning their conversation with low security matters, and wait until the BP provides the threshold security for the more sensitive data. If Alice and Bob are conversing over the phone, then as they start the conversation they might notice a ‘red light’ to indicate they are at risk of exposure, and so they only exchange pleasantries, say, then the light changes to orange and yellow, indicating that the BP procedure builds up security, and some moderately sensitive matters may be exchanged. When the light turns green—the connection is secure for the most sensitive exchange. If Alice and Bob anticipate regular private communication they may establishes security regimen whereby they activate the BP methodology in in-between sessions, and keep increasing their security over time. By so doing they make their communication theft-resistant because every new exchange of data is based on a freshly “baked” security level that was not stored at-risk anywhere, and hence could not have been stolen or compromised by anybody. A special case relates to electronic payment.

Electronic Payment Security:

Paying via an electronic exchange bears an inherent risk, and thus almost all payment procedures entail a measure of security. The common case today is to specify two accounts, the payer's account and the payee's account, and to specify the amount of money that one account has to increase by, and the other to decrease by. If that exchange is compromised then the two accounts are at risk, which implies that the amount of payment may be small, yet the account exposure creates the risk. By contrast paying a digital coin without account exposure ties the risk to the paid amount. And so one could use low security, quick and short application of BP, to protect small payment, and longer and more comprehensive application of BP to protect larger payments. A received digital coin can usually be instantly redeemed and voided, so a hacker who finds the identity of the coin after it has been redeemed will not profit by his knowledge. This fact may relax the security demands from the BP.

### The Setting in which the Private Communication Takes Place

The setting may be classified as:
ad-hoc
Dedicated setting
Generic

In the ad-hoc setting the parties may share this article and based on it mutually decide on the working parameters: the space, the line size, the number of pickings, etc. And then each may program his or her own part, or they may share a program—all this in the open, relying on the heart of the methodology to produce the desired privacy. In a dedicated setting the BP methodology will be programmed in the overall computing process, and be activated as part of the master protocol. Two modes are identified:
disengaged encryption
engaged encryption.

In the disengaged mode the BP program produces a shared secret key, which is then used by an independent cipher, or a hash program etc. In the engaged mode the space used for the BP procedure is also used to apply the encryption per se. Such can be done using the space defined in U.S. Pat. No. 6,823,068. A generic version of the binary privacy will be a pre-set program that expects the following input:
activation signal
parties ID
key size
security level

The generic box will have a communication port connecting it to the communicating port of the opposite party, and it will produce as output:
a secure cryptographic key
progress status

The generic BP box may have to have access to the clouds to read from a generic space there. The product of the BP box will be a k-bits long string that represents a shared secret known to the other party and not to others. The use of this secret key is not the concern of the generic BP box. The user of the shared secret key is likely to regard it as a cryptographic key for use in an agreed upon cipher. The security of that cipher is also outside the concern of the generic BP. Both Alice and Bob will use a copy of the same box, and each will feed into his or her box the matching information. All this information will be exchanged in the public domain. The information exchange between the communication ports may or may not undergo identity verification. The BP tool is not concerned with identities, only with continuity—shared secret between the parties to the protocol, regardless of who they are. The required security will be defined by the estimated time required of a cryptanalyst privy to all the communication between Alice and Bob to cryptanalyze the shared secret of Alice and Bob. This time will be estimated based on the expected speed of the cryptanalyst's computer, on the time delay for each round, and the cumulative equivocation. If the security requirement is high, then the BP protocol will have to run more rounds, and it will take more time to achieve the required security. Some sort of progress meter may be fitted to inform the user how much longer before the required security is expected to be achieved. The same configuration will work for the case where Alice and Bob are acquainted, and had exchanged a secret key between them. This exchanged key will be used to build the space and the lines on it, so that Eve's starting point will be much more difficult, she will not know the size and the nature of the space, as she would in the case of Alice and Bob being strangers. In that case the added security required by the BP protocol will be minimal.

### Multilateral Privacy

The method described herein is essentially bilateral. The chances that x>2 parties will each choose n elements out of a set of s elements, such that all x parties will have a single shared picked element are rapidly decreasing with the increase of x. That means that in order for three or more parties to randomly pick a shared element, the value of the size of the picked set, n will have to be much higher than it is in the bilateral case. However, a multi-lateral secret can be built and even augmented by sharing one or more bilateral secrets: Let Alice and Bob use the bilateral privacy method described here, and secure a shared secret K_{AB}. Subsequently, or in parallel, Alice secures a bilateral secret with Carla: K_{AC}. Alice would then communicate K_{AB} to Carla, (using their shared secret K_{AC}), and in parallel she communicates K_{AC} to Bob (using their shared secret K_{AB}). As a result Alice, Bob and Carla now share the combined secret: K_{AB}+K_{AC}, which they can use to share private communications among the three of them. Alice could then execute a bilateral privacy procedure with David, and produce her shared secret with him: K_{AD}. She will then create a foursome community: Alice, Bob, Carla, and David, sharing the combined secret key: K_{AB}+K_{AC}+K_{AD}. It does not have to be Alice who keeps adding bilateral secrets to a combined secret, it can be any member of the shared secret community. In fact, a community of q=2^{t} parties, t=3, 4, . . . could divide into 0.5q pairs, where each pair in parallel execute this bilateral privacy procedure, resulting in 0.5q shared secrets. Then one of each pair executes the BP procedure with one party of another pair, this adds up 0.25q secrets. Then the groups of four parties each share bilaterally with each other, and so on. So q member community will exercise the BP procedure t−1 times, and establish a q-lateral shared privacy.

What is claim is:

1. A method to achieve an entropic advantage between two strangers (Alice and Bob) against an eavesdropper (Eve) who is privy to all the communication between Alice and Bob; the method is based on Alice randomly selecting nₐ items from a set of n items, and Bob randomly selecting n_{b} items from the same set, such that a subsequent conversation between Alice and Bob reveals to them whether they have both selected one same item, which if they did, becomes their shared secret unknown to Eve, and if they did not they repeat the random selections until they do find a single common item they both selected.

2. A method as in (1) where the subsequent conversation is based on the n items having each p properties, and each property i=1, 2 . . . p has v(i) values, and where Alice randomly selects a property i=1, 2, . . . p and lists for Bob all the values of property i to be found within her chosen nₐ items, and thereby Bob can mark off any item in his selection (n_{b}) that has a value for property i that is not on Alice's list, and where Bob then lists for Alice the values that appear in his selected set (n_{b}) per a randomly selected property j=1, 2, . . . , (i−1), (i+1), . . . p, prompting Alice to mark off items for which the value of their j property is not in Bob's list, and where Alice repeats the above via a randomly selected property k=1, 2 . . . (i−1), (i+1), . . . (j−1), (j+1), . . . p over the items in her set that remain viable candidates for a common selection with Bob, and where Bob does the same for yet another property l=1, 2 . . . (i−1), (i+1), . . . (j−1), (j+1), . . . (k−1), (k+1) . . . p over the items in his set which are still viable candidates for a common selection with Alice, and so on, until Alice and Bob are each left with one viable item that remains as a possible candidate for a common selection, or until they conclude that they have no selection in common, or have more than one selection in common; in both cases, Alice and Bob reselect nₐ and n_{b} items respectively, and repeat the process until they find a single shared selected item, that item being Alice and Bob shared secret, unknown to Eve, at least for a while.

3. A method like in (2) where Alice and Bob stop the cycle when each of them has m>1 or more items as viable sharing candidates and where Alice and Bob apply a one-way function over the remaining viable candidates in order to conclude whether they have one selected item in common.

4. A method to construct an equivocation-based one-way function by a transformation of Z+->Z+ such that if a positive integer X is transformed to positive integer Y, then there are infinite positive integers: X₁, X₂, . . . such that they all transform into Y using the same transformation procedure (algorithm).

5. The method in (4) where the transformation is such that the transformed positive integer X is divided into two integers: X=U and V, where U is interpreted as the guide to transform V into Y, such that given Y, one could pick an arbitrary V′, perhaps subject to some restrictions, such that, one could extract from Y and V′, a fitting U′ such that U′ and V′ combine to X′ and hence X′ also transforms to Y, using the same procedure.

6. A method as in (5) where X is written as a binary string, which is divided to two binary strings U and V, such that they concatenate into X, and such that U is interpreted as a guide to build a key as described in U.S. Pat. No. 6,823,068, and V is interpreted as the binary string that is encrypted using that key, and where Y is the corresponding ciphertext.
